(19) United States
(12) Patent Application Publication
(10) Pub. No.: US 2016/0232420 A1
(43) Pub. Date: Aug. 11, 2016

(54) METHOD AND APPARATUS FOR PROCESSING SIGNAL DATA

(71) Applicant: Nokia Technologies Oy, Espoo (FI)

(72) Inventors: Lixin Fan, Tampere (FI); Kimmo Roimela, Tampere (FI); Yu You, Kangasala (FI); Sounak Bhattacharya, Tampere (FI)

(21) Appl. No.: 15/015,071

(22) Filed: Feb. 3, 2016

(30) Foreign Application Priority Data
Feb. 5, 2015 (GB) 1501877.3

(51) Int. Cl. G06K 9/46

(52) U.S. Cl. CPC G06K 9/4647

(57) ABSTRACT

A method, comprising:
providing a first border array associated with a first block, the first border array comprising several elements, wherein the value of each element corresponds to the sum of signal values of pixels enclosed within an integration region within said first block,
providing a second border array associated with a second block, the second border array comprising several elements, wherein the value of each element corresponds to the sum of signal values of pixels enclosed within an integration region within said second block,
determining a first representative element from the first border array according to a calculation point,
determining a second representative element from the second border array according to said calculation point, and
calculating a sum of signal values of pixels located within a summation region by using the first representative element and the second representative element, said summation region having a corner at said calculation point.

### FIELD

Some variations may relate to processing signal data.

### BACKGROUND

An integral image may comprise a plurality of elements arranged in a two-dimensional array such that each element has an integrated value. The integral image may also be called e.g. as a summed area table. Each element of the integral image may contain the sum of signal values of all pixels located on the up-left region of an original image, in relation to the element's position. The integral image may be used e.g. for pattern recognition. The size of an integral image may sometimes be very large. For example, a single integral image may represent the whole earth, and may comprise e.g. 2³²×2³²=2⁶⁴ pixels. It may be difficult to store this integral image in a computer memory. It may be difficult to use this integral image fast and efficiently. Updating of this integral image may require a high number of data processing operations.

### SUMMARY

Some variations may relate to a method for processing signal data. Some variations may relate to an apparatus for processing signal data. Some variations may relate to a computer program for processing signal data. Some variations may relate to a data structure.

According to an aspect, there is provided a method for processing signal data, the signal data representing a spatial region, the method comprising:
providing a first border array associated with a first block, the first border array comprising several elements, wherein the value of each element corresponds to the sum of signal values of pixels enclosed within an integration region within said first block,
providing a second border array associated with a second block, the second border array comprising several elements, wherein the value of each element corresponds to the sum of signal values of pixels enclosed within an integration region within said second block,
determining a first representative element from the first border array according to a calculation point,
determining a second representative element from the second border array according to said calculation point, and
calculating a sum of signal values of pixels located within a summation region by using the first representative element and the second representative element, said summation region having a corner at said calculation point.

According to an aspect, there is provided a computer program comprising computer program code configured to, when executed on at least one processor, cause an apparatus or a system to:
provide a first border array associated with a first block, the first border array comprising several elements, wherein the value of each element corresponds to the sum of signal values of pixels enclosed within an integration region within said first block,
provide a second border array associated with a second block, the second border array comprising several elements, wherein the value of each element corresponds to the sum of signal values of pixels enclosed within an integration region within said second block,
determine a first representative element from the first border array according to a calculation point,
determine a second representative element from the second border array according to said calculation point, and
calculate a sum of signal values of pixels located within a summation region by using the first representative element and the second representative element, said summation region having a corner at said calculation point.

According to an aspect, there is provided a computer program product embodied on a non-transitory computer readable medium, comprising computer program code configured to, when executed on at least one processor, cause an apparatus or a system to:
provide a first border array associated with a first block, the first border array comprising several elements, wherein the value of each element corresponds to the sum of signal values of pixels enclosed within an integration region within said first block,
provide a second border array associated with a second block, the second border array comprising several elements, wherein the value of each element corresponds to the sum of signal values of pixels enclosed within an integration region within said second block,
determine a first representative element from the first border array according to a calculation point,
determine a second representative element from the second border array according to said calculation point, and
calculate a sum of signal values of pixels located within a summation region by using the first representative element and the second representative element, said summation region having a corner at said calculation point.

According to an aspect, there is provided a means for processing signal data, comprising:
means for providing a first border array associated with a first block, the first border array comprising several elements, wherein the value of each element corresponds to the sum of signal values of pixels enclosed within an integration region within said first block,
means for providing a second border array associated with a second block, the second border array comprising several elements, wherein the value of each element corresponds to the sum of signal values of pixels enclosed within an integration region within said second block,
means for determining a first representative element from the first border array according to a calculation point,
means for determining a second representative element from the second border array according to said calculation point, and
means for calculating a sum of signal values of pixels located within a summation region by using the first representative element and the second representative element, said summation region having a corner at said calculation point.

According to an aspect, there is provided an apparatus comprising at least one processor, a memory including computer program code, the memory and the computer program code configured to, with the at least one processor, cause the apparatus to at least:
provide a first border array associated with a first block, the first border array comprising several elements, wherein the value of each element corresponds to the sum of signal values of pixels enclosed within an integration region within said first block,
provide a second border array associated with a second block, the second border array comprising several elements, wherein the value of each element corresponds to the sum of signal values of pixels enclosed within an integration region within said second block,
determine a first representative element from the first border array according to a calculation point,
determine a second representative element from the second border array according to said calculation point, and
calculate a sum of signal values of pixels located within a summation region by using the first representative element and the second representative element, said summation region having a corner at said calculation point.

According to an aspect, there is provided a hierarchical data structure for processing signal data, the signal data representing a spatial region, the data structure comprising:
a first border array for a first block,
a second border array for a second block,
a third border array for a first child block of said first block,
a fourth border array for a second child block of said first block,
   wherein the value of each element of the first border array corresponds to the sum of signal values of pixels enclosed within an integration region within said first block, the value of each element of the second border array corresponds to the sum of signal values of pixels enclosed within an integration region within said second block, the value of each element of the third border array corresponds to the sum of signal values of pixels enclosed within an integration region within said third block, the value of each element of the fourth border array corresponds to the sum of signal values of pixels enclosed within an integration region within said fourth block, the first block encloses the third block and the fourth block, the first block does not overlap the second block, the first border array has a first identifier code, the second border array has a second identifier code, the third border array has a third identifier code, the fourth border array has a fourth identifier code, the third identifier code comprises a code section which corresponds to the first identifier code, and the fourth identifier code comprises a code section which corresponds to the first identifier code.

Various aspects are defined in the claims.

Signal data DATA1 may comprise signal values f of a plurality of pixels B. The pixels B may be arranged e.g. in a two-dimensional array or in a three-dimensional array. The signal values may be e.g. intensity values captured by an imaging device. The signal values may be e.g. concentration values measured by a laser measurement system. The term “pixel” may refer to a two-dimensional pixel and/or to a three-dimensional pixel. The three-dimensional pixels may also be called e.g. as a voxels.

Processing of the data may comprise integration of signal values over a two-dimensional or three-dimensional summation region, i.e. determining a regional sum of signal values of pixels of said summation region.

The signal data may represent a spatial region. The spatial region may be partitioned into a plurality of pixels. The signal data may comprise signals values of a plurality of pixels. The spatial region may also be partitioned into a plurality of blocks, and each block may be subsequently partitioned into sub-blocks. The sub-blocks may also be called e.g. as child blocks or as descendant blocks. The blocks may together form a hierarchical coarse-to-fine block system. Each block may enclose one or more pixels of the signal data.

A summation region may be a rectangle or a rectangular box. The summation region may have a first corner at the (global) origin and a second corner at a calculation point P(x,y) or at a calculation point P(x,y,z). A regional sum of signal values of pixels of a 2D or 3D summation region may be determined by calculating the sum of values of two or more representative elements. The method may comprise calculating a sum of representative elements for a calculation point P(x,y) or P(x,y,z). The regional sum may be determined by identifying which blocks overlap with the summation region, by determining a single representative element for each overlapping block, and by calculating the sum of the representative elements. The number of the representative elements may be substantially lower than the number of pixels contained in the summation region. Consequently, calculating the regional sum as a sum of representative elements may significantly shorten the time needed for performing the data processing operations.

Each block may be associated with one or more border arrays. Each border array may comprise several pre-calculated elements. The representative element of a block may be determined by selecting from pre-calculated elements of a border array of said block, depending on the position of the calculation point P(x,y) or P(x,y,z). The values of the elements of a border array of a block may be determined by summing the signal values of pixels enclosed within an integration region within said single block.

The representative element of a block may be selected from the elements of a border array of said block according to the position of the calculation point. The representative element may be selected from the elements of the border array e.g. by determining which element is closest to the calculation point P(x,y,z), wherein said element is also enclosed by the summation region.

The representative elements may be determined e.g. by using a hierarchical coarse-to-fine block system. In case of 2D signal data, a hierarchical 2D block system may be used. In case of 3D signal data, a hierarchical 3D block system may be used. The number of the representative elements used for the summation may be relatively low even in case of very large signal data.

Each block may be represented by a single representing element. The blocks used for calculation of the sum may be selected such that the summation region can be filled with the minimum number of blocks, In other words, only the largest blocks which are enclosed by the summation region and/or only the largest blocks which provide a representative element need be taken into consideration. Blocks which are outside the summation region may be omitted when calculating the regional sum.

The border array of a block depends only on signal values within said single block. Consequently, a change of signal value in a first block does not cause a change of a border array of a second adjacent block. Thus updating of the data structure may require a relatively small number of data processing operations (i.e. “computing”).

If the summation region overlaps a block but does not enclose any elements of a border array of said block, then the value of the representative element of said block may be determined e.g. by integrating signal values of pixels within said block.

If the summation region overlaps a block but does not enclose any elements of a border array of said block (and if the summation region does not enclose any elements of a border array of a descendant block of said block), then the value of the representative element of said block may be determined e.g. by integrating signal values of pixels within said (single) block.

The method may comprise using the following types of data:
integrated values within a single block, and
border arrays.

By using these two sets of data, the integrated signal value may be determined for any summation region, which overlaps two or more adjacent blocks.

Calculating the integral as a sum of representative elements may make it possible to process large amounts of signal data fast and efficiently. In particular, calculating the regional sum as the sum of representative elements may allow rapid pattern recognition.

Calculating the regional sum as a sum of representative elements may allow calculation of the regional sum at the global scale. Calculating the regional sum as a sum of representative elements may facilitate e.g. processing of 3D/2D map data at the global scale.

### BRIEF DESCRIPTION OF THE DRAWINGS

In the following examples, several variations will be described in more detail with reference to the appended drawings, in which

FIG. 1a shows, by way of example, signal data,

FIG. 1b shows, by way of example, signal data representing a geographical area,

FIG. 2 shows, by way of example, in a three dimensional view, partitioning of 2D blocks into a plurality of 2D descendant blocks,

FIG. 3a shows, by way of example, signal data comprising pixels in a 2D array,

FIG. 3b shows, by way of example, elements of an integral image determined from the signal data of FIG. 3a,

FIG. 4a shows a border array which is a subset of elements shown in FIG. 3a,

FIG. 4b shows, by way of example, a graphical symbol of a border array,

FIG. 4c shows a border array which is a subset of elements shown in FIG. 3a,

FIG. 4d shows a border array which is a subset of elements shown in FIG. 3a,

FIG. 5a shows, by way of example, partitioning of signal data into several spatial regions,

FIG. 5b shows, by way of example, integral images calculated separately for each spatial region of FIG. 5a,

FIG. 6a shows, by way of example, in a three dimensional view, descendant blocks of a parent block,

FIG. 6b shows, by way of example, a hierarchical tree data structure,

FIG. 6c shows, by way of example, border array data arranged according to the hierarchical tree data structure,

FIG. 7a shows, by way of example, blocks overlapping with a summation region, which has a first corner at a calculation point, and a second corner at the global origin,

FIG. 7b shows, by way of example, determining representative values, according to the summation region of FIG. 7b,

FIG. 8a shows, by way of example, a block which is enclosed by the summation region,

FIG. 8b shows, by way of example, a block which overlaps the summation region,

FIG. 8c shows, by way of example, a block which overlaps the summation region,

FIG. 8d shows, by way of example, blocks overlapping with the summation region,

FIG. 9a shows, by way of example, in a three dimensional view, a cubical block,

FIG. 9b shows, by way of example, in a three dimensional view, determining the values of the elements of the border array of the block of FIG. 9a,

FIG. 9c shows in a three dimensional view, the border array of the block of FIG. 9a,

FIG. 10a shows, by way of example, in a three dimensional view, partitioning a cubical block into a plurality of descendant blocks,

FIG. 10b shows, by way of example, in a three dimensional view, partitioning the block of FIG. 10a into a plurality of elements,

FIG. 10c shows, by way of example, in a three dimensional view, determining the values of the elements of a border array of the block of FIG. 10a,

FIG. 10d shows by way of example, in a three dimensional view, the border array of the block of FIG. 10a,

FIG. 11a shows, by way of example, in a three dimensional view, a plurality of cubical blocks,

FIG. 11b shows, by way of example, in a three dimensional view, a rectangular summation box defined by a calculation point, and cubical blocks overlapping with said rectangular summation box,

FIG. 11c shows, by way of example, in a three dimensional view, the border array of a cubical block, which overlaps with the rectangular summation box defined by the calculation point,

FIG. 11d shows, by way of example, in a three dimensional view, the border array of a cubical block, which overlaps with the rectangular summation box defined by the calculation point,

FIG. 11e shows, by way of example, in a three dimensional view, the border array of a cubical block, which overlaps with the rectangular summation box defined by the calculation point,

FIG. 11f shows, by way of example, in a three dimensional view, the border array of a cubical block, which overlaps with the rectangular summation box defined by the calculation point,

FIG. 11g shows, by way of example, in a three dimensional view, the border array of a cubical block, which overlaps with the rectangular summation box defined by the calculation point,

FIG. 12a shows, by way of example, in a three dimensional view, a rectangular box defined by a calculation point, and cubical blocks overlapping with said rectangular summation box,

FIG. 12b shows, by way of example, in a three dimensional view, the border arrays of cubical blocks, overlapping with the rectangular summation box defined by the calculation point,

FIG. 13 shows, by way of example, method steps for calculating the sum of representative elements of the blocks,

FIG. 14 shows, by way of example, an apparatus which may be configured to carry out the method of FIG. 13, and

FIG. 15 shows, by way of example, a communication system,

### DETAILED DESCRIPTION

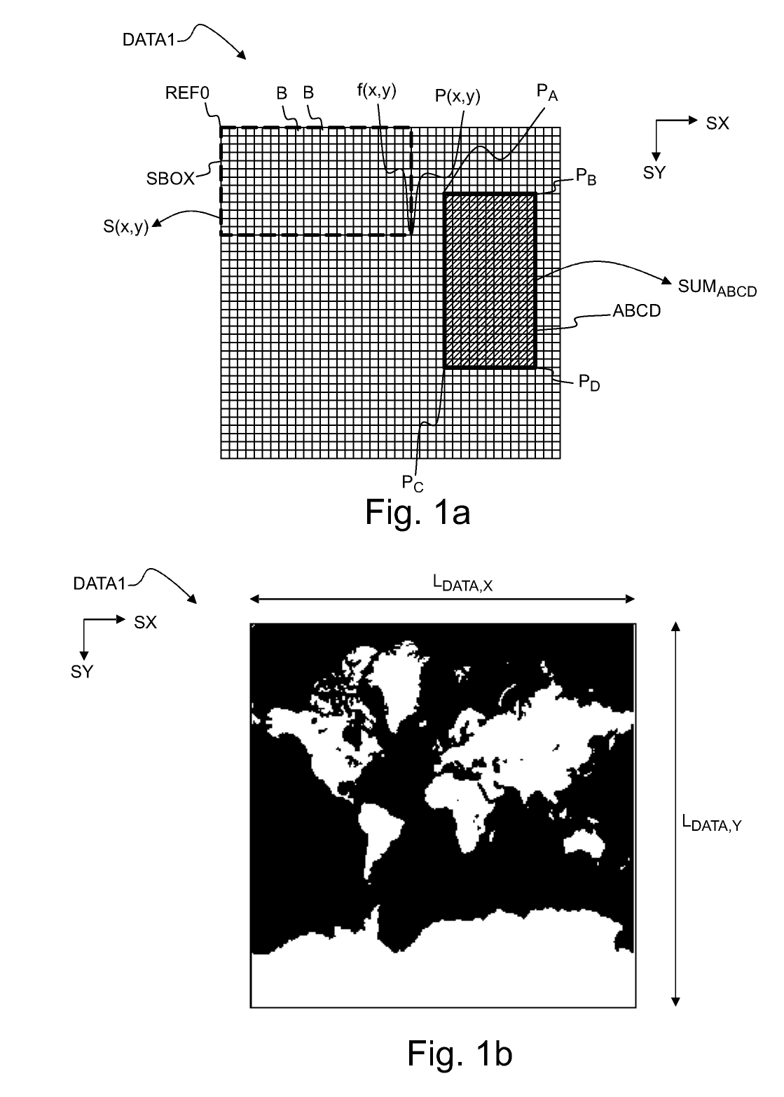

Referring to FIG. 1a, signal data DATA1 may comprise signal values f of a plurality of pixels B. The pixels B may be arranged e.g. in a two-dimensional array. Each pixel B may have a signal value f. The position of each pixel B may be defined e.g. by coordinates (x,y). f(x,y) may denote the signal value of a pixel B, which is at a position (x,y).

The signal values may be e.g. intensity values or brightness values captured by an imaging device. The signal values may be e.g. concentration values measured by a laser measurement system. Processing of the data DATA1 may comprise integration of signal values over a two-dimensional region, i.e. determining a regional sum of signal values of pixels of the two-dimensional region.

P(x,y) may denote a calculation point, which has coordinates (x,y). SBOX may denote a summation region, which may have a first corner at the calculation point P(x,y), and a second corner at the global origin REF0. The summation region SBOX may be a rectangle in the 2D situation. The summation region SBOX may be a rectangular box in the 3D situation. S(x,y) may denote the sum of signal values f of pixels B enclosed by the summation region SBOX, which has a corner at the calculation point P(x,y).

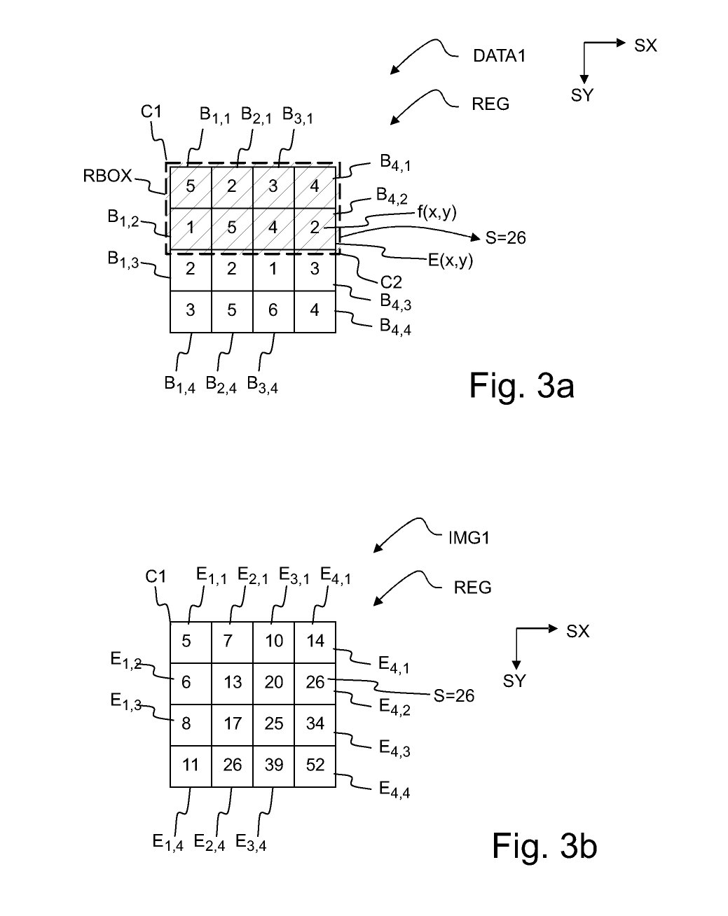

An integral image may comprise a plurality of elements arranged in a two-dimensional array such that each element has an integrated value. An integral image IMG1 is shown e.g. in FIG. 3b. The integral image may also be called e.g. as a summed area table. Each element of the integral image may contain the sum of signal values f of all pixels B located on the up-left region of an original image, in relation to the element's position. The integrated value S(x,y) for a calculation point P(x,y) may be equal to the sum of signal values f of all pixels B located on the up-left region of the signal data DATA1, in relation to position of said calculation point P(x,y). Each element may have a unique spatial position, which may be specified e.g. by coordinates (x,y) or (x,y,z).

Determining the integrated value S(x,y) for the calculation point P(x,y) may be used e.g. for pattern recognition.

The position of a pixel or the position of an element may be specified e.g. by coordinates (x,y). The integrated value S(x,y) at a pixel (x,y) may be calculated recursively e.g. by using the following equation:

S(x,y)=f(x,y)+S(x−1,y)+S(x,y−1)−S(x−1,y−1) (1)

where f(x,y) denotes the signal value at the position (x,y), S(x−1,y) denotes the integrated value at the position (x−1,y), S(x,y−1) denotes the integrated value at the position (x,y−1), and S(x−1,y−1) denotes the integrated value at the position (x−1,y−1).

An advantage of using an integral image is that, the sum of signal values of pixels in a rectangular area inside the image may be calculated substantially in a constant time. In other words, the sum of signal values of pixels in the rectangular area may be calculated in a time, which may be substantially independent of the size of the rectangular area.

Points P_{A}, P_{B}, P_{C}, P_{D} may define a rectangular area ABCD. SUM_{ABCD} may denote the sum of signal values f of pixels B enclosed by the rectangle ABCD. The signal values f may be integrated over the region ABCD, e.g. in order to analyze the signal data DATA1. The integral of signal values f over the region ABCD may be equal to SUM_{ABCD}.

The sum SUM_{ABDC} of pixels in the rectangular area ABCD may be computed e.g. using the following equation:

SUM_{ABCD}=S(P_{D})−S(P_{B})−S(P_{C})+S(P_{A}) (2)

where S(P_{A}) denotes the integrated value at the point P_{A}, S(P_{B}) denotes the integrated value at the point P_{B}, S(P_{C}) denotes the integrated value at the point P_{C}, and S(P_{D}) denotes the integrated value at the point P_{D}. The integrated value S(P_{A}) at the point P_{A} may be determined e.g. by using the point P_{A} as the calculation point P(x,y).

The calculation of equation (2) may be performed by using 4 array access operations. The calculation of the sum SUM_{ABDC} of pixels in the rectangular area ABCD may be used e.g. for pattern recognition.

The calculation of the sum SUM_{ABDC} of pixels in the rectangular area ABCD may be used e.g. for determining whether an image comprises a portion, which matches with a reference pattern. The calculation of the sum SUM_{ABDC} of pixels in the rectangular area ABCD may be used e.g. for face recognition.

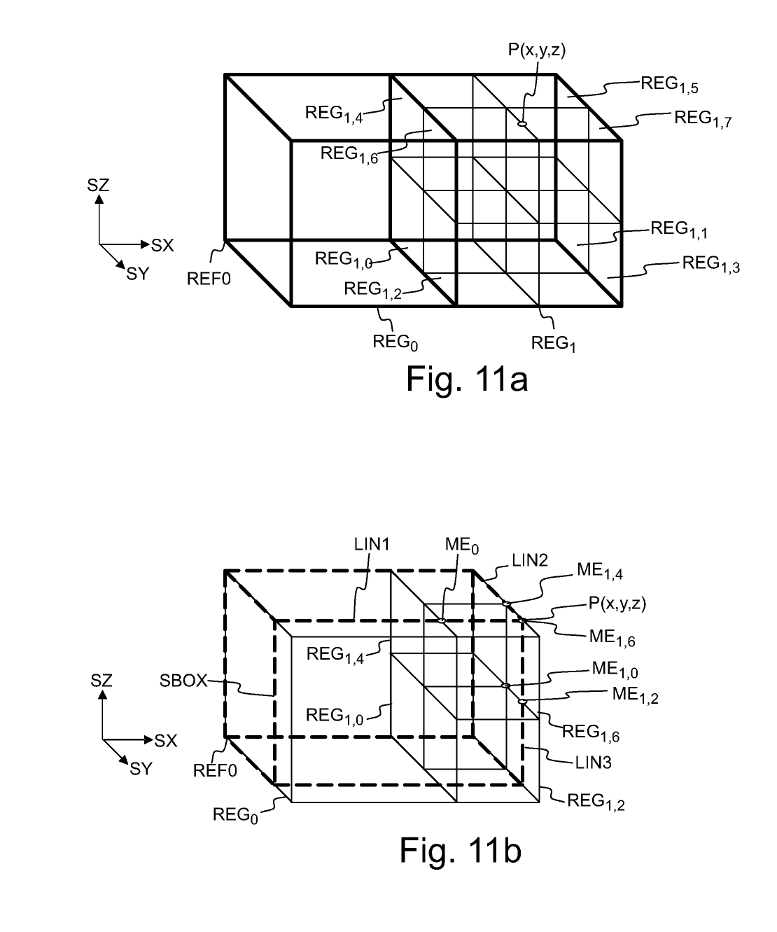

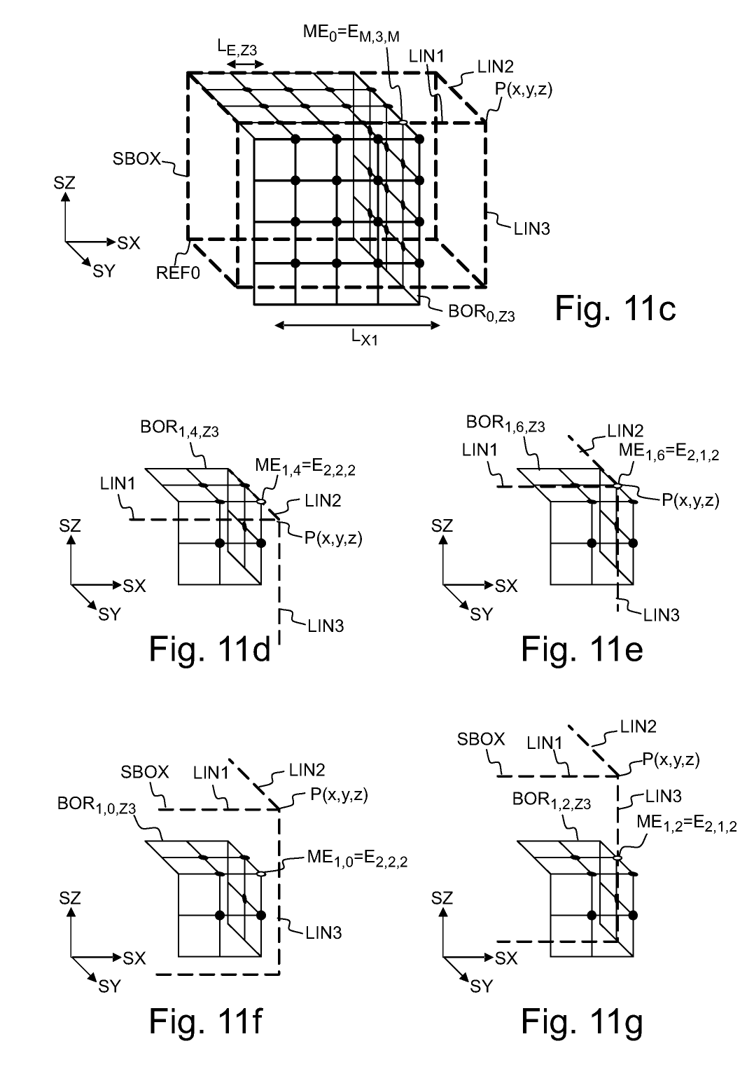

The coordinate x may define a position in the direction SX. The coordinate y may define a position in the direction SY. SX, SY, and SZ may denote orthogonal directions. The coordinate z may define a position in the direction SZ (see e.g. FIG. 11b). The position of each pixel B may be defined e.g. by coordinates (x,y,z) in the 3D situation. f(x,y,z) may denote the signal value of a pixel B, which is at a position (x,y,z). P(x,y,z) may denote a calculation point, which has coordinates (x,y). SBOX may denote a summation region, which may have a first corner at the calculation point P(x,y,z), and a second corner at the global origin REF0. The summation region SBOX may be a rectangular box in the 3D situation. S(x,y,z) may denote the sum of signal values f of pixels B enclosed by the summation region SBOX. 2D is an acronym for two-dimensional, and 3D is an acronym for three-dimensional.

Referring to FIG. 1b, the signal data DATA1 may represent a spatial region, which may have a dimension L_{DATA,X} in the direction SX, and a dimension L_{DATA,Y} in the direction SY. The signal data DATA1 may represent e.g. geographical data. The data DATA1 may represent e.g. the whole earth. For example, the DATA1 may comprise e.g. 2³²×2³² pixels. The dimension L_{DATA,X} may correspond e.g. to 2³² pixels, and the dimension L_{DATA,X} may correspond to e.g. 2³² pixels. The dimension L_{DATA,X} may be equal to 2³² times the width of a single pixel B. The dimension L_{DATA,Y} may be equal to 2³² times the height of a single pixel B.

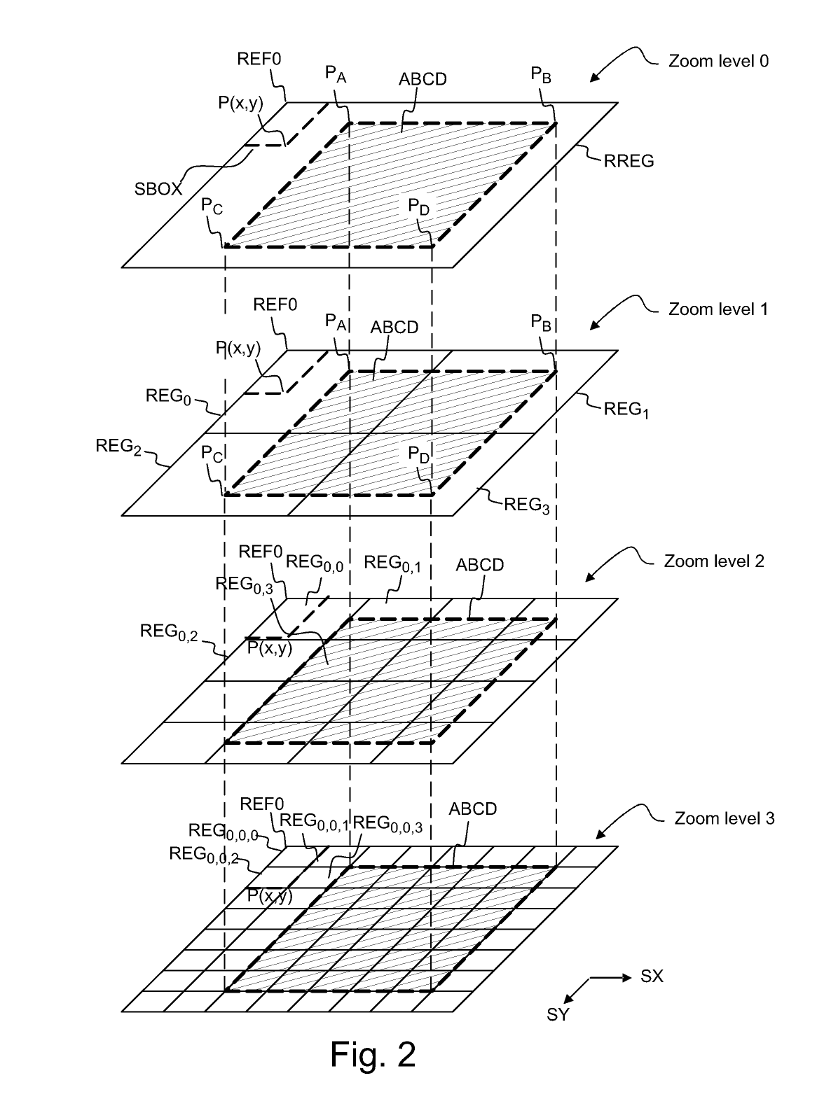

Referring to FIG. 2, a single rectangular region RREG may enclose all pixels of the signal data DATA1. The region RREG may be divided into four regions REG₀, REG₁, REG₂, REG₃. Depending on the situation, the regions may also be called e.g. as blocks, sub-blocks, child blocks, descendant blocks, leaf blocks, parent blocks or ancestor blocks.

The region RREG may be called e.g. as a root block.

The block REG₀ may be further divided into four child blocks REG_{0,0}, REG_{0,1}, REG_{0,2}, REG_{0,3}. The block REG₀ may be a parent block of the child blocks REG_{0,0}, REG_{0,1}, REG_{0,2}, REG_{0,3}.

The block REG_{0,0} may be further divided into four child blocks regions REG_{0,0,0}, REG_{0,0,1}, REG_{0,0,2}, REG_{0,0,3}. The block REG_{0,0} may be a parent block of the child blocks REG_{0,0,0}, REG_{0,0,1}, REG_{0,0,2}, REG_{0,0,3}.

The blocks RREG, REG₀, REG_{0,0} may be ancestor blocks of the descendant blocks REG_{0,0,0}, REG_{0,0,1}, REG_{0,0,2}, REG_{0,0,3}.

The root block RREG may represent a zoom level 0. The blocks REG₀, REG₁, REG₂, REG₃ may represent a first zoom level 1. The blocks REG_{0,0}, REG_{0,1}, REG_{0,2}, REG_{0,3} may represent a second zoom level 2. The blocks REG_{0,0,0}, REG_{0,0,1}, REG_{0,0,2}, REG_{0,0,3} may represent a third zoom level 3. The smallest blocks at the maximum zoom level may also be called e.g. as pixels (B) or as leaf blocks.

The blocks may cover e.g. a geographical area. Using the blocks to represent geographical data may facilitate e.g. panning a map or zooming a geographical map. Using the blocks to represent geographical data may facilitate e.g. map retrieval and/or displaying the geographical data.

The maximum zoom level may be e.g. 32. In case of geographical data representing the whole earth, the maximum zoom level may provide e.g. a spatial resolution of 40000 km/2³² (≈0.5 cm).

The blocks may also be called e.g. as tiles. In case of geographical data, the blocks may also be called e.g. as map tiles.

FIG. 3a shows, by way of example, signal data DATA1, which comprises pixels B in a two-dimensional array. The data DATA1 may comprise pixels B e.g. in a 4×4 array. Each pixel B may have a signal value f. A block REG may enclose the 4×4 pixels B of the data DATA1.

Referring to FIG. 3b, the block REG may comprise one or more elements E. The elements may be arranged e.g. in a two-dimensional array. The size of the elements of the block REG may be larger than or equal to the size of the pixels B of the signal data DATA1. In this example, the size of the elements E of the block REG is equal to the size of the pixels of the data DATA1. The block REG may comprise elements E arranged in an M×M formation, where M denotes an integer.

For example, the block REG may comprise e.g. 16 elements E arranged in a 4×4 array. Each element E may have an integrated signal value S. Each element E of the region REG may be associated with an integrated value S. The integrated value S of an element E may be equal to the sum of the signal values f of pixels B enclosed with a rectangular integration region SBOX, which has a first corner at the position of said element E and a second corner at the upper left corner of said region REG.

The value S of each element E may be determined by integrating signal values f over an integration region RBOX of the first block, said integration region RBOX having a corner C2 at the position of an element of the first block. The integration region RBOX may have a corner C1 at a predetermined corner of the block REG. In particular, the integration region RBOX may have a corner C1 at the upper left corner of the block REG.

FIG. 3a shows, by way of example, an integration region RBOX for determining the integrated signal value of the element E_{4,2}. The sum of the signal values f of pixels B enclosed by the integration region RBOX may be e.g. equal to 26.

FIG. 3b shows, by way of example, the integrated signal values S for each element E of the block REG. The integrated signal values S may together form the integral image IMG1 of the data DATA1 enclosed by the block REG.

A block REG may comprise a group of elements E arranged in a two-dimensional array. Each element E may have an integrated signal value S. The integrated signal value S_{i,j} of an element E_{i,j} may be determined by integrating signal values f over a rectangular integration region RBOX, wherein the integration region RBOX may have a first corner C2 at the position of said element E_{i,j}. The integration region RBOX may have a second corner C1 at a predetermined corner of the block REG. In particular, the integration region may have a second corner C1 e.g. at the upper left corner of the block REG. The block may be far away from the global origin REF0. When calculating the values of the elements E_{i,j}, the position of the corner C1 (and position of the corner C2) may be different from the position of the global origin REF0.

The block REG may comprise a plurality of elements E arranged in a two dimensional array or in a three-dimensional array. The elements E may be arranged e.g. in a 4×4 array. The elements E may be arranged e.g. in a M×M array, wherein M denotes a positive integer. The integer M may be e.g. equal to 4.

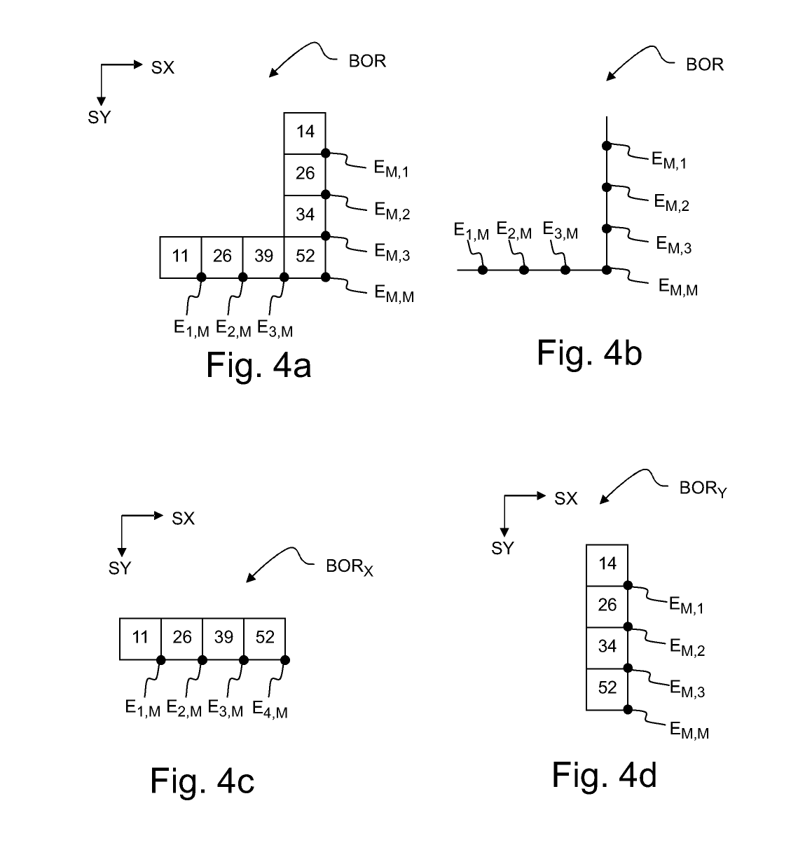

Referring to FIG. 4a, border elements of the block REG may constitute a border array BOR of the block REG. The border array BOR may also be called e.g. as the border vector or as a group of border elements. The border array may be a subset of the elements enclosed by the block. FIG. 4b shows, by way of example, a simplified graphical symbol representing a border array. Referring to FIG. 4c, a border array BOR_{X} may comprise the lowermost row of elements E of the block REG. Referring to FIG. 4d, a border array BOR_{Y} may comprise elements E of the last column on the right of a block REG. FIG. 4c shows a border array, which consists of the elements E of the lowermost row of the block REG. FIG. 4d shows a border array, which consists of the elements E of the last column on the right of a block REG.

A block REG may be associated with one or more border arrays BOR of said block REG. The block REG may have e.g. a key or a reference to one or more border arrays BOR. The boundary of the block REG may enclose all elements E of the border array BOR of said block. Each element of a border array of the block may have a unique position within said block, when compared with the other elements of said border array. The number of elements of a border vector of a block may be substantially smaller than the number of pixels contained in said block.

The spatially integrated values may be represented e.g. as a local integral image (in the 2D situation) or as integral volumes (in the 3D situation). The computation of a local integral image or an integral volume may be restricted to a single block. The computation of a local integral image or an integral volume may be restricted to a single block at the desired level of resolution.

The border arrays may also be called e.g. as local integral boundaries. The border array may comprise e.g. a one-dimensional array of elements. The value of each element of a border array of a block may be determined by integrating signal values over a rectangular integration region of the block, said integration region having a corner at the position of said element. The border arrays may be determined by calculating the integral images of all blocks at the maximum zoom level (i.e. at the highest level of detail), and by determining the integral images of the borders at all zoom levels. The values of the elements of the border array may also be found by picking the last row and/or column of the integral image. The size of the integral image may be equal to the size of the block.

The border arrays of the blocks or the border arrays of the blocks may be computed at all levels of blocks.

The size of the border array may increase exponentially with increasing level. If needed, the border array may be stored in a memory by using a lossy or lossless data compression algorithm, e.g. by using run-length encoding.

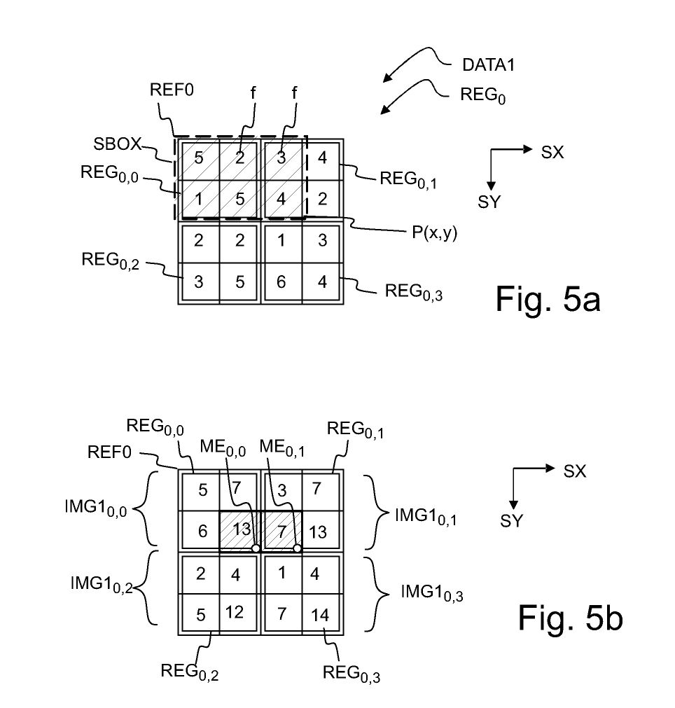

Referring to FIG. 5a, a parent block REG₀ may enclose e.g. 4×4 pixels of data DATA1. Each pixel may have a signal value f. The area of a parent block REG₀ may be divided into several child blocks REG_{0,1}, REG_{0,2}, REG_{0,3}, REG_{0,4}.

FIG. 5b shows integral images IMG1_{0,0}, IMG1_{0,1}, IMG1_{0,2}, IMG1_{0,3} determined separately for each child block REG_{0,0}, REG_{0,1}, REG_{0,2}, REG_{0,3}.

The sum of the signal values f of pixels B encloses by the summation region SBOX may be determined by summing values of representative elements of the blocks. In this example, the sum of the signal values f of pixels B encloses by the summation region SBOX shown in FIG. 5a may be determined by summing the value of the element E_{2,1} of the block REG_{0,0} and the value of the element E_{1,1} of the block REG_{0,1} In this example, the element E_{2,1} may be the representative element of the block REG_{0,0}, and the element E_{1,1} may be the representative element of the block REG_{0,1}. The blocks REG_{0,2}, REG_{0,3} do not need to be taken into consideration because they are outside the summation region SBOX of FIG. 5a. Blocks which do not overlap the summation region SBOX may be ignored when calculating the regional sum.

This simple example illustrates that the regional sum of signal values of pixels of the summation region SBOX may be determined by summing e.g. two or more representative values together. This may represent significant computational advantage when compared with a situation where all (six) signal values within the summation region SBOX of FIG. 5a would be individually added to the sum.

The method may comprise calculating a sum S(x,y) of representative elements ME for a calculation point P(x,y). The method may comprise calculating a sum S(x,y) of a first representative element of a first block and a second representative element of a second block. Each representative element ME of a block may be an element E which is:
located within said block,
closest to said calculation point P(x,y), and
enclosed by the summation region SBOX,

The representative elements ME may be determined e.g. by using a hierarchical coarse-to-fine block system. The method may comprise retrieving the value of an element of a border array by using data stored according to a hierarchical tree structure.

The sum S(x,y) of signal values f of pixels B located within the summation region SBOX may be calculated e.g. by using a first representative element of a first block, and a second representative element of a second block. When calculating the sum, the representative elements of further blocks may also be used, if said further blocks overlap the summation region. The sum may be calculated by summing the representative elements of the blocks which overlap the summation region. The sum may be calculated by calculating the sum of the representative elements of the blocks which overlap the summation region.

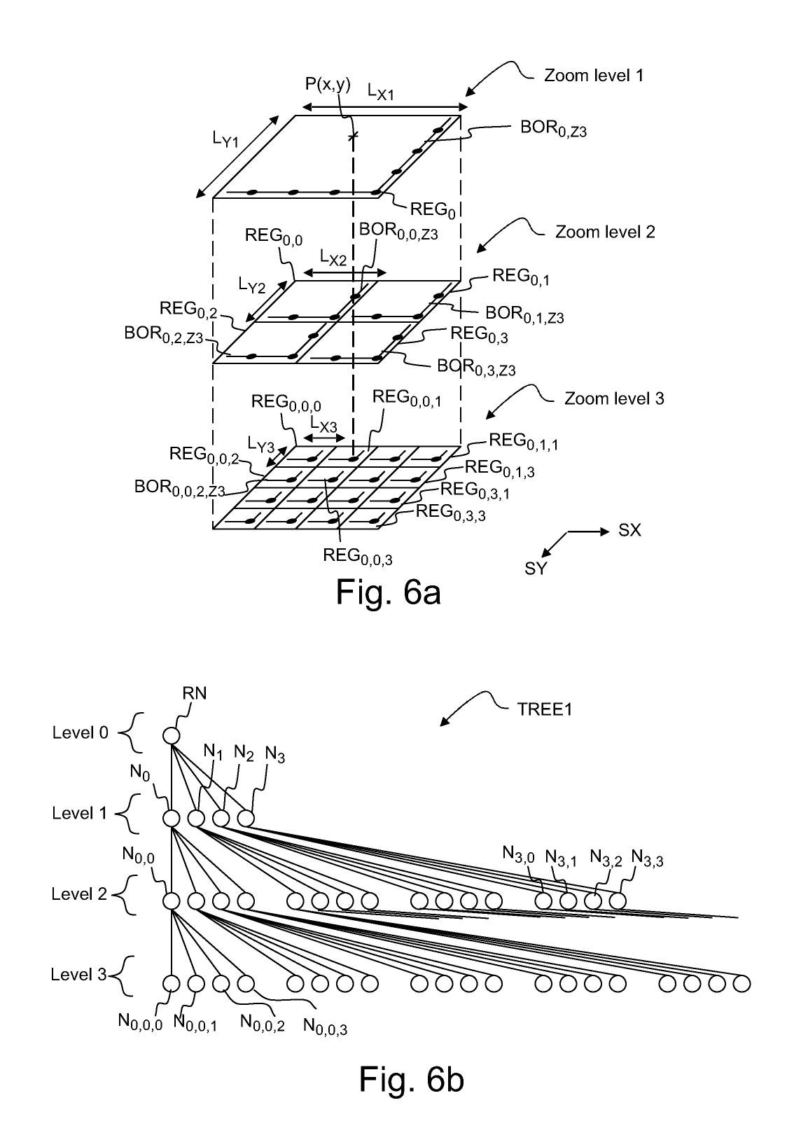

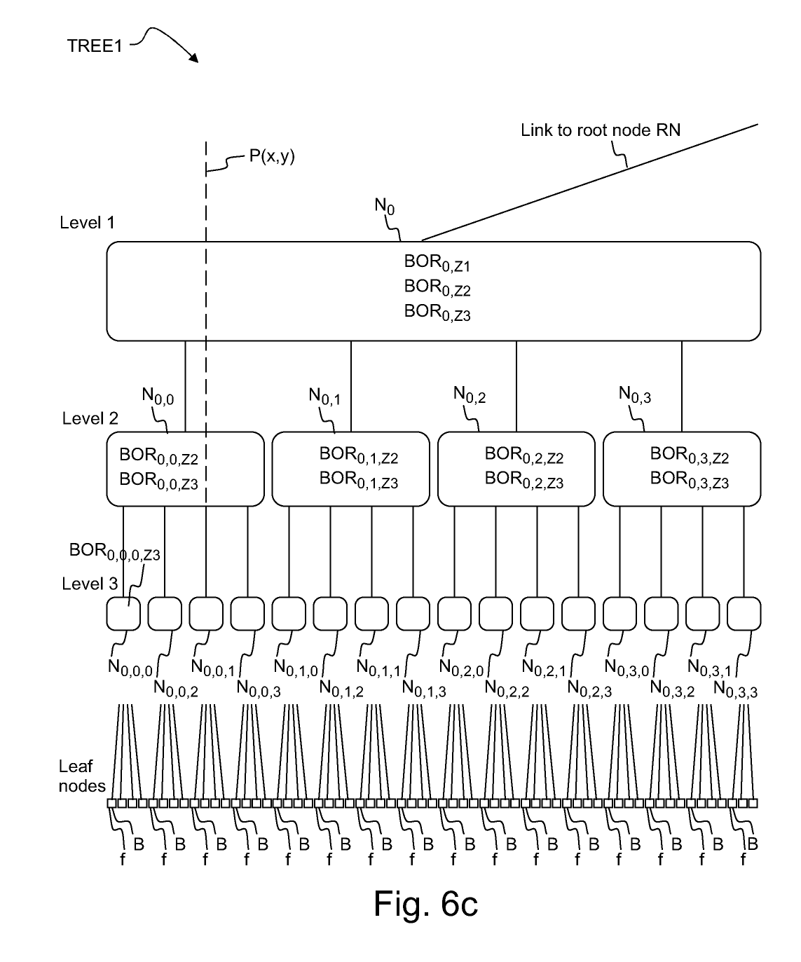

FIG. 6a shows, by way of example partitioning the area of a parent block REG₀ into four child blocks REG_{0,0}, REG_{0,1}, REG_{0,2}, REG_{0,3}. The area of the block REG_{0,0} may be subsequently partitioned into four child blocks REG_{0,0,0}, REG_{0,0,1}, REG_{0,0,2}, REG_{0,0,3}.

A group of child blocks REG_{0,0}, REG_{0,1}, REG_{1,0}, REG_{1,1} may correspond to the area of the parent block REG₀. A group of child blocks REG_{0,0,0}, REG_{0,0,1}, REG_{0,1,0}, REG_{0,1,1} may correspond to the area of the parent block REG_{0,1}. The block REG₀ may belong e.g. to a zoom level 1. The blocks REG_{0,0}, REG_{0,1}, REG_{1,0}, REG_{1,1} may belong e.g. to a zoom level 2. The blocks REG_{0,0,0}, REG_{0,0,1}, REG_{0,1,0}, REG_{0,1,1} may belong e.g. to a zoom level 3.

The block REG₀ may have a dimension L_{X1} in the direction SX and a dimension L_{Y1} in the direction SY. The block REG_{0,0} may have a dimension L_{X2} in the direction SX and a dimension L_{Y2} in the direction SY. The block REG_{0,0,0} may have a dimension L_{X3} in the direction SX and a dimension L_{Y3} in the direction SY. The dimension L_{X1} may be equal to two times the dimension L_{X2}. The dimension L_{X2} may be equal to two times the dimension L_{X3}.

Each block may have one or more border arrays. For example, the block REG0, may be associated with a border array BOR_{0,Z3}. Z3 may indicate e.g. the spatial resolution of the border array BOR_{0,Z3}. The spatial distance between (the centers of) adjacent elements of a border array BOR may be an integer multiple of the distance between (the centers of) adjacent pixels of the signal data DATA1.

The border arrays BOR of the smallest blocks (at the maximum zoom level) may comprise only one element E. The smallest blocks may represent the pixels of the data DATA1. Each smallest block may represent a single pixel of the data DATA1. The value of the element E of the border array of the smallest blocks may be equal to the signal value f of said pixel.

The hierarchical level used may be selected based on the desired spatial resolution. The hierarchical level may be selected such that the blocks provide the desired level of detail. The hierarchical level may also be called e.g. as a zoom level. For example, the blocks of zoom level 1 may have large spatial dimension, which may correspond to low spatial resolution. Blocks of zoom level 2 may have smaller spatial dimension, which may correspond to higher spatial resolution. The bottom level may mean the hierarchical level, which provides highest spatial resolution. The integral may be calculated for the bottom level blocks. The sum of representative elements may be calculated for the bottom level blocks. The blocks of the bottom level may be called e.g. as pixels. Each block of a higher level may correspond to a group of pixels.

The position of each rectangular block REG may be expressed by a 2-dimensional coordinate (x,y), which may be subsequently converted into a 1-dimensional string. The string may be called e.g. as a quadkey.

In the 3D situation, the position of each cubical block REG may be expressed by a 3-dimensional coordinate (x,y,z), which may be subsequently converted into a 1-dimensional string. The string may be called e.g. as a octkey.

Referring to FIG. 6b, information about the blocks may be used and/or stored e.g. according to a hierarchical tree structure TREE1. The blocks REG may form a hierarchical tree structure TREE1. The integrated values and/or the border arrays BOR may be used and/or stored e.g. according to a hierarchical tree structure TREE1. In case of the 2D situation, the hierarchical tree structure may be a quad tree. Each node N of the tree TREE1 may recursively call one child node in order to determine one representative element. Each node N may comprise data for determining a representative element.

Information about the elements of the blocks of the different zoom level 1, level 2, level 3, level 4 may be arranged according to the hierarchical tree data structure TREE1. The tree data structure TREE1 may comprise a root node RN, which may be connected to child nodes N₀, N₁, N₂, N₃. Each child node of the level 1 may be subsequently connected to child nodes of the level 2. For example, the child node N₃ of the level 1 may be connected to child nodes N_{3,0}, N_{3,1}, N_{3,2}, N_{3,3} of the level 2. Each child node of the level 2 may be subsequently connected to child nodes of the level 3. For example, the child node N_{0,0} of the level 2 may be connected to child nodes N_{0,0,0}, N_{0,0,1}, N_{0,0,2}, N_{0,0,3} of the level 3.

The data stored in the tree structure may be accessed e.g. by using a quadkey. Each may uniquely identify a single block at a particular level of detail. The length of the quadkey may be proportional to the zoom level. The quadkeys of ancestor nodes of a given node may be found e.g. by stripping digits from the right hand side of the quadkey of said node.

In the 3D situation, the data stored in the tree structure may be accessed e.g. by using a octkey. Each may uniquely identify a single block at a particular level of detail. The length of the octkey may be proportional to the zoom level. The octkeys of ancestor nodes of a given node may be found e.g. by stripping digits from the right hand side of the octkey of said node.

The identifier code of a descendant node may comprise a code section which corresponds to the identifier code of an ancestor node of said descendant node. The identifier code of a descendant block may comprise a code section which corresponds to the identifier code of an ancestor block of said descendant block. The identifier code of border array of a descendant block may comprise a code section which corresponds to the identifier code of border array of an ancestor block of said descendant block.

The hierarchical tree data structure may comprise:
a first border array for a first block,
a second border array for a second block,
a third border array for a first child block of said first block,
a fourth border array for a second child block of said first block,
   the first border array having a first identifier code,
   the second border array having a second identifier code,
   the third border array having a third identifier code,
   the fourth border array having a fourth identifier code,
   wherein the third identifier code comprises a code section which corresponds to the first identifier code, and
   the fourth identifier code comprises a code section which corresponds to the first identifier code.

Each node may call only one of its child nodes recursively. Thus, the computational complexity may be proportional to the depth of the tree. The computational complexity may be proportional to the depth of the quad tree. Each node may have e.g. four child nodes or less. Some regions may lack data. Thus the tree is not always a full quad tree, because many nodes do not have child nodes, due to lack of data.

Child nodes corresponding to a calculation point may be called from lower and lower levels until a child node provides a representative element which spatially coincides with the calculation point.

The tree TREE1 may comprise nodes e.g. at 24 levels. The tree may comprise e.g. geographical data representing the whole earth such that the dimension of the largest block at the root node may be e.g. 40000 km, and the dimension of the smallest block at the lowermost level may be e.g. 2.4 cm (=40000 km/2²⁴).

Modifying data stored in the tree may comprise addition and/or deletion of data at the lowermost level, i.e. the leaf nodes of the tree may be modified. All ancestor nodes of the modified leaf node may also be updated. Thus, three may be updated partially. The partial updating may make computing of integral images at large scale computationally efficient.

Determining the representative elements by using the tree structure may provide a fast and/or feasible solution for computing the integral images of 2D map data at the global scale. Determining the representative elements by using the tree structure may provide a fast and/or feasible solution for computing the integral volumes of 3D map data at the global scale.

Storing the data in the hierarchical tree structure TREE1 may enable computationally efficient updating of an integral image after a partial updating of data stored in the tree structure.

The minimum information stored in a node of the tree TREE1 may include:
a quadkey (2D) or an octkey (3D) unique for the node;
If the node is at the bottom level, the node may comprise an integral image or integral volumes;
If the node is at an upper level, the node may comprise one or more border arrays.

Information may be stored only for those nodes for which signal data is available. Thus, a node may be omitted from the tree TREE1 and/or one or more nodes may be empty if signal data is not available for said node.

The information of a node may be stored by using lossless or lossy compression. The size of the border arrays stored at the nodes of the higher levels may be very large. If needed, the border array may be stored in a memory by using lossy or lossless data compression algorithm, e.g. by using run-length encoding.

The hierarchical tree data structure may be updated such that a border array of a leaf block is updated, and the border arrays of the ancestor blocks of said leaf block are updated.

Referring to FIG. 6c, each node of the tree TREE1 may be associated with a block, and an individual node of the tree TREE1 may comprise one or more border arrays for the same block. Each parent node of the tree TREE1 may comprise one or more border arrays. The leaf nodes of the tree TREE1 may be associated with the pixels B. An individual leaf node may comprise a signal value f of a single pixel B. The leaf nodes do not need to comprise border arrays.

For example, the node N0 may comprise border arrays BOR_{0,Z1}, BOR_{0,Z2}, BOR_{0,Z3} for the block REG₀. The border array used for determining the representative element may be selected based on the desired spatial resolution of the calculations. The border array BOR_{0,Z1} may be used when the desired resolution corresponds to the zoom level 1. The border array BOR_{0,Z2} may be used when the desired resolution corresponds to the zoom level 2. The border array BOR_{0,Z3} may be used when the desired resolution corresponds to the zoom level 3. Each border array may be associated with an identifier code, which may associate the border array with a block. In particular, each border array may have an identifier code, which may associate the border array with a block.

For example, a node N_{0,0} may comprise border arrays BOR_{0,0,Z2}, BOR_{0,0,Z3}, for the block REG_{0,0}. A node N_{0,1} may comprise border arrays BOR_{0,0,Z2}, BOR_{0,0,Z3}, for the block REG_{0,1}. A node N_{0,2} may comprise border arrays BOR_{0,2,Z2}, BOR_{0,2,Z3}, for the block REG_{0,0,2}. A node N_{0,3} may comprise border arrays BOR_{0,3,Z2}, BOR_{0,3,Z3}, for the block REG_{0,0,3}.

The leaf nodes of the tree TREE1 do not need to comprise border arrays. The leaf nodes of the tree TREE1 may comprise signal values f of the pixels B. Each leaf node B may comprise only one signal value f.

An ancestor block may comprise all descendant blocks of said ancestor block. Consequently, an arbitrary point which coincides with a descendant block may also be located within all ancestor blocks of said descendant block. For example, the calculation pixel P(x,y,z) may spatially coincide e.g. with the block REG_{0,0,1}. Consequently said point P(x,y,z) may be located within all ancestor blocks REG_{0,1}, and REG₀ of said block REG_{0,0, 1}.

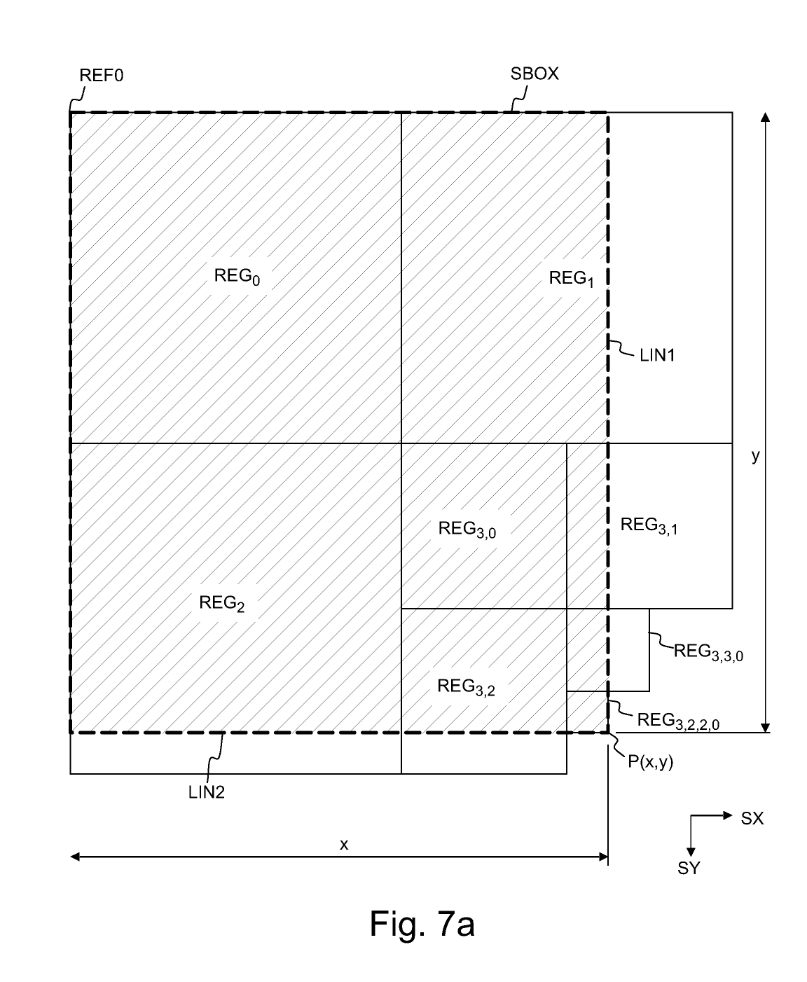

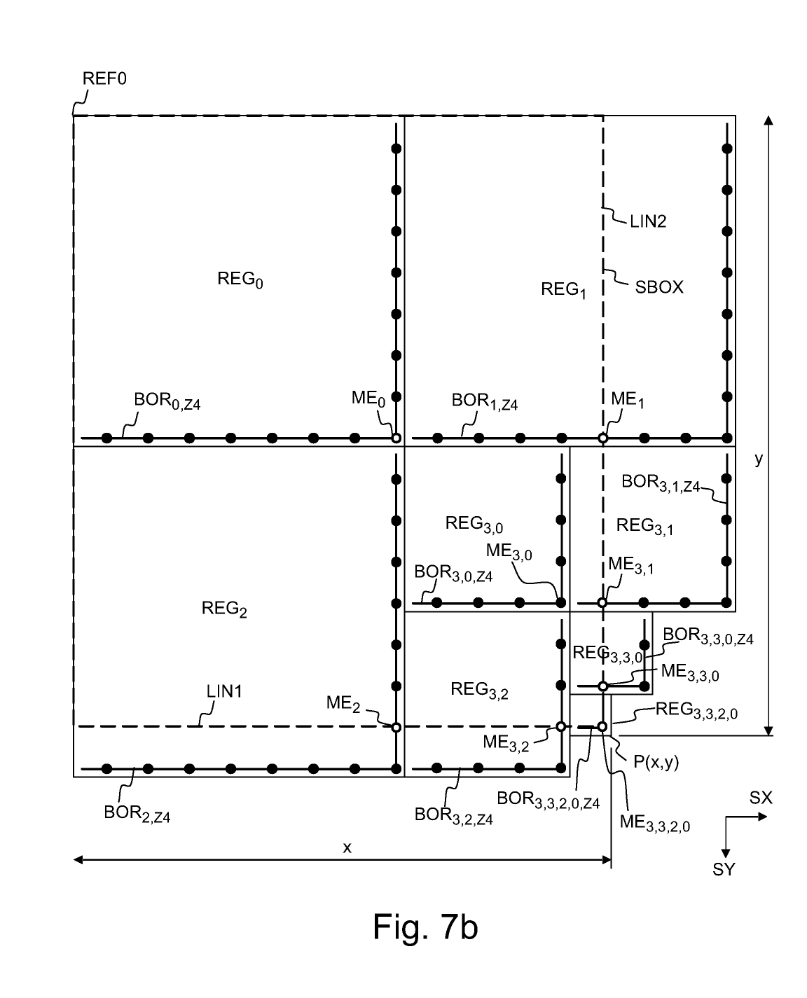

Referring to FIG. 7a, the calculation point P(x,y) may define the position of a corner of a summation region SBOX. The summation region SBOX may be a rectangle in the 2D situation. The summation region may be a rectangular box in the 3D situation. The summation region may have a second corner at the global origin REF0. The global origin REF0 may be e.g. at the upper left corner of the block REG₀. The summation region SBOX may have a first boundary line LIN1 and a second boundary line LIN2. The first line LIN1 may be parallel with the direction SX, and the second line LIN2 may be parallel with the direction SY. The first line LIN1 and a second line LIN2 may meet at the calculation point P(x,y).

The shaded area of FIG. 7a indicates the area or volume enclosed by the summation region SBOX. The summation region SBOX may enclose a complete block or only a part of a block, depending on the position of the calculation point P(x,y), depending on the position of a block, and depending on the size of the block. For example, the summation region SBOX may enclose the regions REG₀, REG_{3,0}, and REG_{3,2,2,0}. For example, the summation region SBOX may enclose a part of the regions REG₁, REG₂, REG_{3,1}, REG_{3,2}. Yet, some blocks may be completely outside the summation region SBOX.

Referring to FIG. 7b, each block which overlaps the summation region SBOX may be represented by a representative element ME. The integral S_{BOX} of signal values f over the summation region SBOX may be determined by calculating a sum of the representative elements ME of the blocks, which overlap the summation region SBOX. In this example, the integral S_{BOX} may be equal to the sum of the values of the representative elements ME of the blocks REG₀, REG₁, REG₂, REG_{3,0}, REG_{3,1}, REG_{3,2}, and REG_{3,2,2,0}.

The method may comprise:
providing a first border array BOR_{1,Z4} associated with a first block REG₁, the first border array BOR_{1,Z4} comprising several elements, wherein the value of each element corresponds to the sum of signal values of pixels enclosed within an integration region within said first block REG₁,
providing a second border array BOR_{2,Z4} associated with a second block REG₂, the second border array BOR_{2,Z4} comprising several elements, wherein the value of each element corresponds to the sum of signal values of pixels enclosed within an integration region within said second block,
determining a first representative element ME₁ from the first border array BOR_{1,Z4} according to a calculation point P(x,y),
determining a second representative element ME₂ from the second border array BOR_{2,Z4} according to said calculation point P(x,y), and
calculating a sum S_{BOX} of signal values f of pixels B located within a summation region SBOX by using the first representative element ME₁ and the second representative element ME₂, said summation region SBOX having a corner at said calculation point P(x,y). The representative element of a block may be determined from the elements of the border array of said block such that the representative element has the minimum spatial distance to the calculation point P(x,y) or P(x,y,z). A representative element (e.g. ME₁) may be selected from the elements of a border array (e.g. BOR_{1,Z4}) such that the representative element has the minimum distance to said calculation point P(x,y), wherein the representative element is also enclosed by the summation region. The distance may be e.g. the Manhattan distance or the Euclidean distance.

The boundary (e.g. LIN2) of said summation region SBOX may meet the first border array BOR_{1,Z4}.

The position of the first representative element ME₁ may coincide with the position of the calculation point P(x,y) in at least one of the orthogonal directions (SX, SY) of the coordinate system. In other words, the first representative element ME₁ and the calculation point P(x,y) may have the same x-coordinate and/or the same y-coordinate.

A block may be enclosed by the summation region. In that case, the corner element of the border array of a block may be closest to the calculation point P(x,y,), and said corner element may be used as the representative element of said block. For example, the summation region SBOX may enclose the block REG₀, and the corner element of the border vector BOR_{0,Z4} may be used as the representative element ME0 of the block REG₀. When the summation region SBOX completely encloses a block REG, then the representative element ME may be the corner element of the border array of said block.

The blocks may have different sizes. For example, a first block REG₁ may be adjacent to a second block REG_{3,0}, and the first block may be larger than the second block.

The boundary line LIN1 or LIN2 of the summation region SBOX may intersect the border array BOR of a block REG at an intersection point. The representative element ME may be selected from the elements E of the border array BOR according to the position of the intersection point. The boundary LIN1 or LIN2 of the summation region SBOX may intersect the border array BOR of a block REG at the position of the representative element ME.

The representative element ME may coincide with the boundary LIN1 or LIN2 of the summation region SBOX. The representative element ME may be selected from the elements of the border array of said block such that that the calculation point and the representative element have the same position (x) in the direction SX or the same position (y) in the direction SY.

When the boundary of the summation region SBOX does not intersect an element of the border array of a parent block, then a descendant block of said parent may need to be used. The representative element ME may be selected from the elements of the border array of the descendant block such that that the calculation point and the representative element have the same position (x) in the direction SX or the same position (y) in the direction SY.

If the summation region overlaps a block but does not enclose any elements of a border array of said block, and if the summation region does not enclose any elements of a border array of a descendant block of said block, then the value of the representative element of said block may be determined e.g. by integrating signal values of pixels within said (single) block.

When calculating the sum of the representative elements, the blocks may be selected such that a minimum number of blocks need to be used. The largest blocks overlapping with the summation region may be used.

When calculating the sum of the representative elements, a block may be used for the summation when:
the summation region SBOX encloses at least one element of a border array of said block, and
the summation region SBOX does not enclose at least one element of a border array of a parent block of said block.

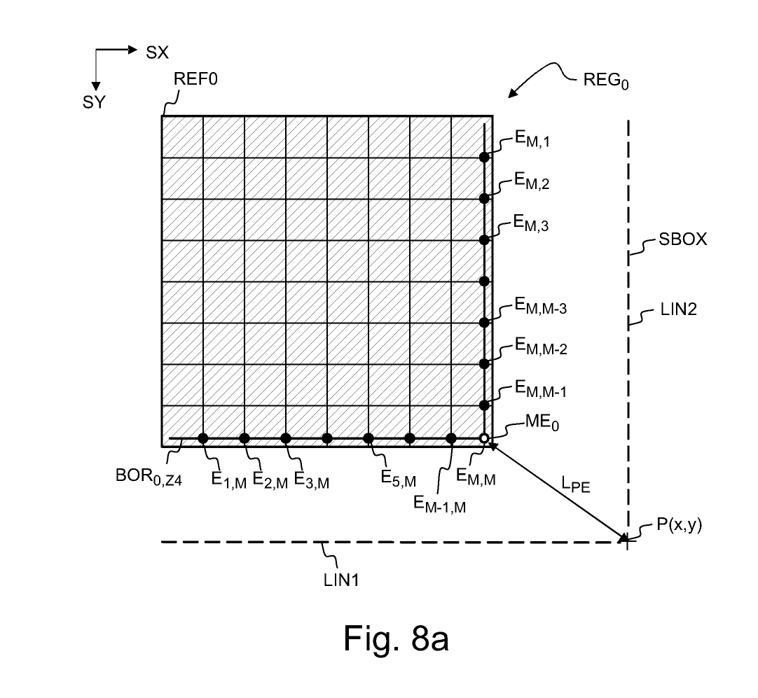

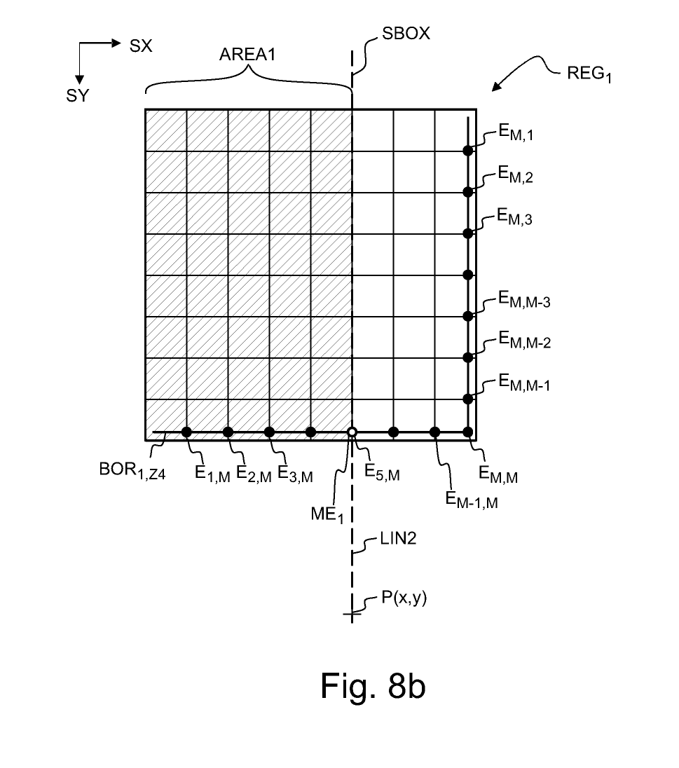

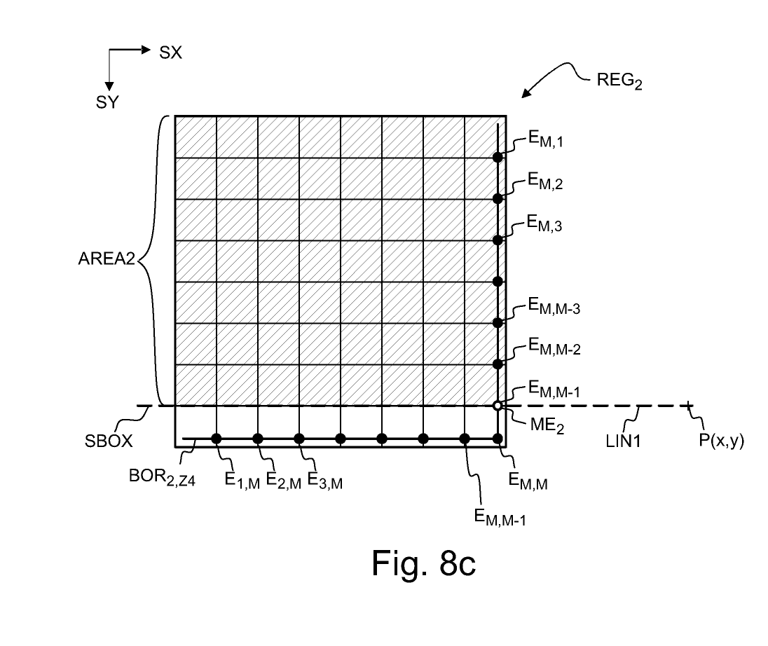

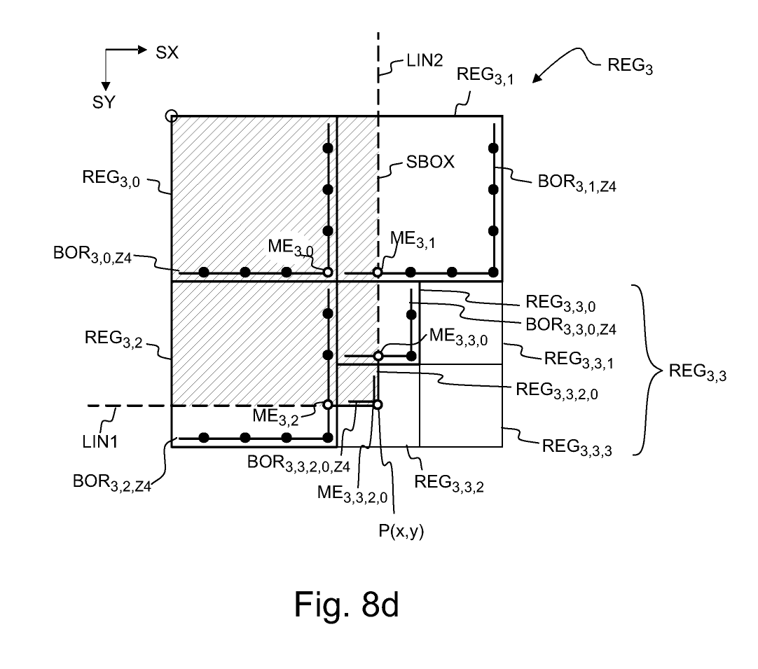

FIG. 8a shows, by way of example, a situation where the corner element E_{M,M} of the border array BOR_{0,Z4} has the minimum distance L_{PE} to the calculation point P(x,y). In this case, the distance between any other element of the border array and the calculation point P(x,y) is greater than the distance between the corner element E_{M,M} and the calculation point P(x,y). In particular, the distance between the adjacent element E_{M,M-1} and the calculation point P(x,y) is greater than the distance between the corner element E_{M,M} and the calculation point P(x,y).

In this case, the summation region SBOX encloses the block REG₀, and the corner element E_{M,M} of the border array BOR_{0,Z4} may be used as the representative element ME of the block REG₀.

The parameter Z4 may indicate the level of detail of the border array.

Also an integer number M may also indicate the level of detail of the border array. In the 2D situation, the number of elements of the border array BOR_{0,Z4} may be equal to 2−M−1. The integer number M may indicate the spatial resolution of the border array.

If the signal values of all pixels are positive, then the value of the representative element of a block may be higher than the value of any other element which is enclosed by the summation region and which belongs to the border array of said block.

FIG. 8b shows, by way of example, a situation where the element E_{5,M} has the minimum distance to the calculation point P(x,y). The boundary line LIN2 of the summation region SBOX may intersect the border array BOR_{1,Z4} of the block REG₁ at the position of an element (e.g. the element E_{5,M}). The coinciding element (E_{5,M}) may be used as the representative element of the block REG₁. The summation region SBOX may enclose an area AREA1 of the block REG₁.

FIG. 8c shows, by way of example, a situation where the element E_{M,M-1} has the minimum distance to the calculation point P(x,y). The boundary line LIN1 of the summation region SBOX may intersect the border array BOR_{2,Z4} of the block REG₂ at an element (e.g. the element E_{M,M-1}). The element E_{M,M-1} at the boundary LIN1 may be used as the representative element ME of the block REG₂.

The summation region SBOX may enclose an area AREA2 of the block REG₂.

FIG. 8d shows, by way of example, a situation where the summation region SBOX does not enclose any element of the border array of the block REG₃.

The summation region SBOX encloses a part of the block REG₃ but the boundary of the summation region SBOX does not intersect the boundary array of the block REG₃. In that case, one or more child blocks REG_{3,0}, REG_{3,1}, REG_{3,2}, REG_{3,3} of the parent block REG₃ may be used.

The representative elements ME_{3,0},ME_{3,1},ME_{3,2},ME_{3,3,0},ME_{3,3,2,0} may be selected from the elements of the border arrays such that the representative elements have the minimum distance to the calculation point P(x,y).

The summation region SBOX may enclose the block REG_{3,0}. The corner element of the border array BOR_{3,0,Z4} of the block REG_{3,0} may be used as the representative element ME of the block REG_{3,0.}

The boundary of the summation region SBOX may intersect the boundary arrays of the blocks REG_{3,1}, REG_{3,2}. In this case, the boundary of the summation region SBOX does not intersect the boundary array of the block REG_{3,3}, and one or more child blocks REG_{3,3,0}, REG_{3,3,1}, REG_{3,3,2}, REG_{3,3,3} of the parent block REG_{3,3} may be used.

In this case, the boundary of the summation region SBOX may enclose the block REG_{3,3,0}, but does not overlap with the blocks REG_{3,3,1}, and REG_{3,3,3}. Consequently, the signal values in the area of the blocks REG_{3,3,1} and REG_{3,3,3} do not contribute to the summation.

The summation region SBOX may enclose the block REG_{3,3,2,0}. The corner element of the border array BOR_{3,3,2,0,Z4} of the block REG_{3,3,2,0} may be used as the representative element ME of the block REG_{3,3, 2,0}. At the highest level of detail (e.g. at the zoom level 4 or “Z4”), the border array BOR may comprise only one element, i.e. the corner element.

The blocks needed for calculating the sum of representative elements may be determined e.g. by using the hierarchical tree structure TREE1.

In case of 3D signal data, the method may comprise calculating a regional sum of signal values f of pixels B of a three-dimensional summation region. In case of the case of 3D signal data, the pixels may be tree-dimensional. In case of the case of 3D signal data, the pixels may also be called e.g. as pixels. 3D signal data may comprise signal values associated with a plurality of pixels. The pixels B may be arranged in a three-dimensional array. Processing of 3D data may comprise integration of signal values f over a three-dimensional region SBOX, i.e. determining a regional sum of signal values f of pixels B of the three-dimensional region. In case of 3D signal data, a hierarchical 3D block system may be used.

The value of each element E of the border array BOR may be determined by integrating signal values f over a rectangular integration box RBOX within a single block REG, said integration box RBOX having a corner at the position (x,y,z) of said element E. In the 3D situation, the integral values for a single block may form a cube, which has a dimension M×M×M. The border array BOR may comprise elements on a first face of a cube, on a second face of a cube, and on a third face of a cube such that the first face, the second face, and the third face meet at the same corner of the cube. The first face may comprise M×M elements, the second face may comprise M×M elements, and the third face may comprise M×M elements. The elements of the three faces may be stored e.g. as a single two-dimensional array.

The integral volumes may extend the concept of the integral image to three dimensions. The integrated value of a selected pixel (x,y,z) may be calculated by summing signal values of pixels located within a rectangular summation box, which has a corner at the position (x,y,z) of the selected pixel. A second corner of the rectangular summation box may coincide with the global origin REF0. The integrated value of a pixel (x,y,z) at a calculation position (x,y,z) may be calculated by summing signal values of pixels located within the rectangular summation box, which has a corner at said calculation position (x,y,z).

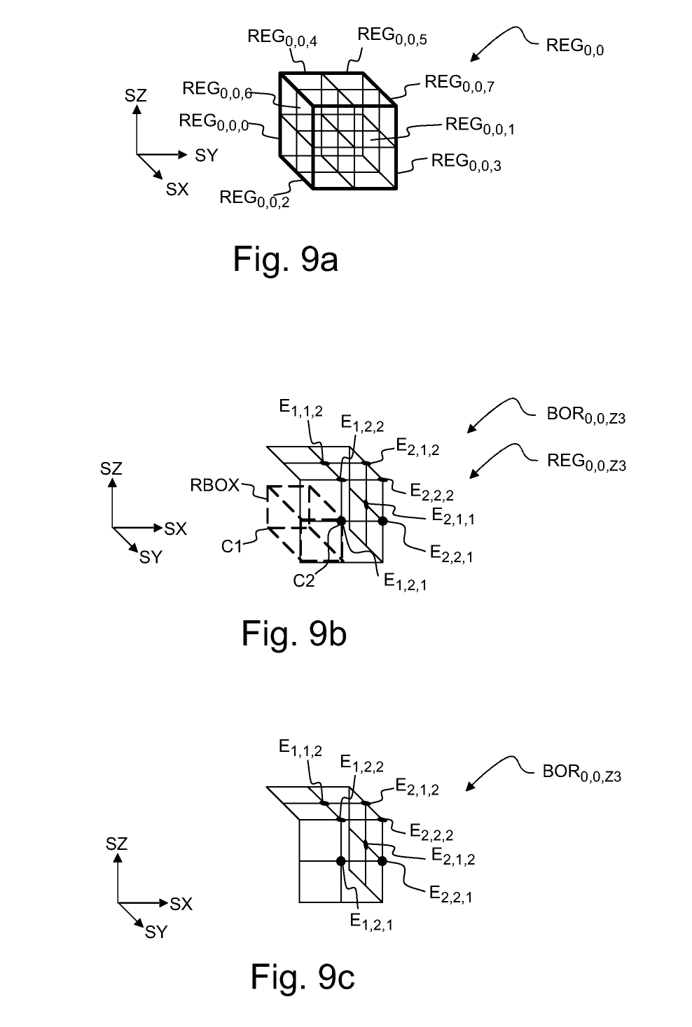

FIG. 9a shows, by way of example, a cubical block REG_{0,0}, which comprises eight child blocks REG_{0,0,0}, REG_{0,0,1}, REG_{0,0,2}, REG_{0,0,3}, REG_{0,0,4}, REG_{0,0,5}, REG_{0,0,6}, REG_{0,0,7}. Said child blocks may together occupy the volume of the block REG_{0,0}.

FIG. 9b shows, by way of example, determining the values of elements E of the border array BOR_{0,0,Z3} of a block REG_{0,0,0}. The value of each element E of a block may be determined by calculating the sum of signal values f of pixels enclosed in a rectangular integration box RBOX, wherein a first corner C1 of the box RBOX is at a predetermined corner of said block, and wherein a second corner C2 of the box RBOX is at the position of said element E.

Referring to FIG. 9c, the border array BOR_{0,0,Z3} of the block REG_{0,0,0} may correspond to a partition where the block REG_{0,0,0} is partitioned into 2³ sub-blocks. The border array BOR_{0,0,Z3} corresponding to said partition may have e.g. elements E_{1,1,2}, E_{1,2,2}, E_{2,1,2}, E_{2,2,2}, E_{2,1,1}, E_{2,2,1}, E_{1,2,1.}

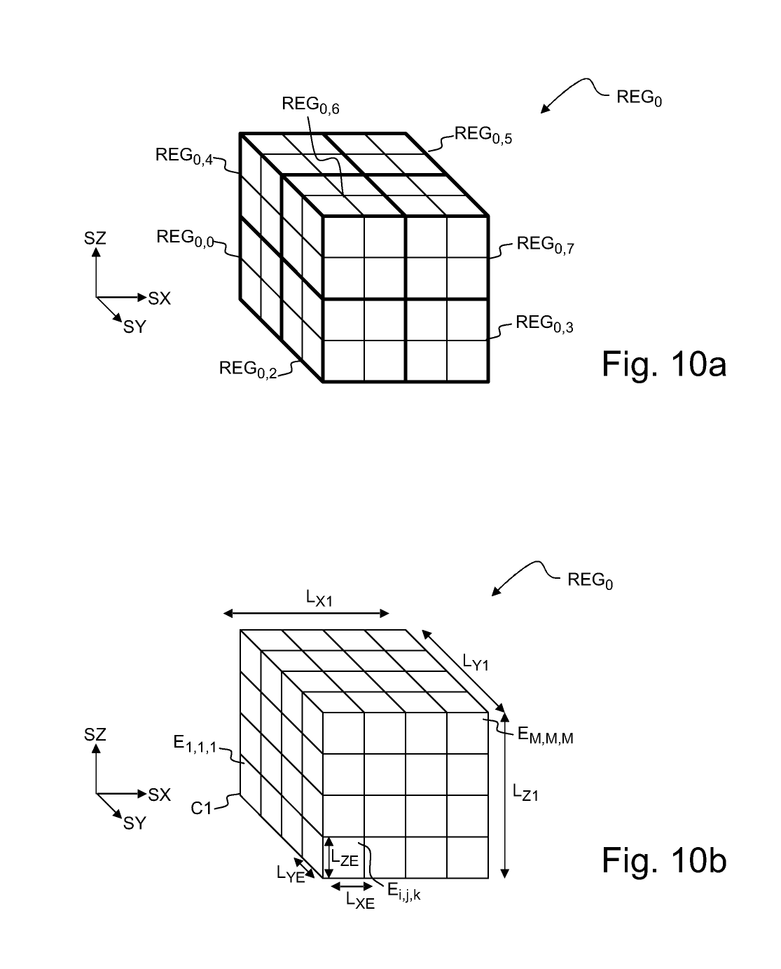

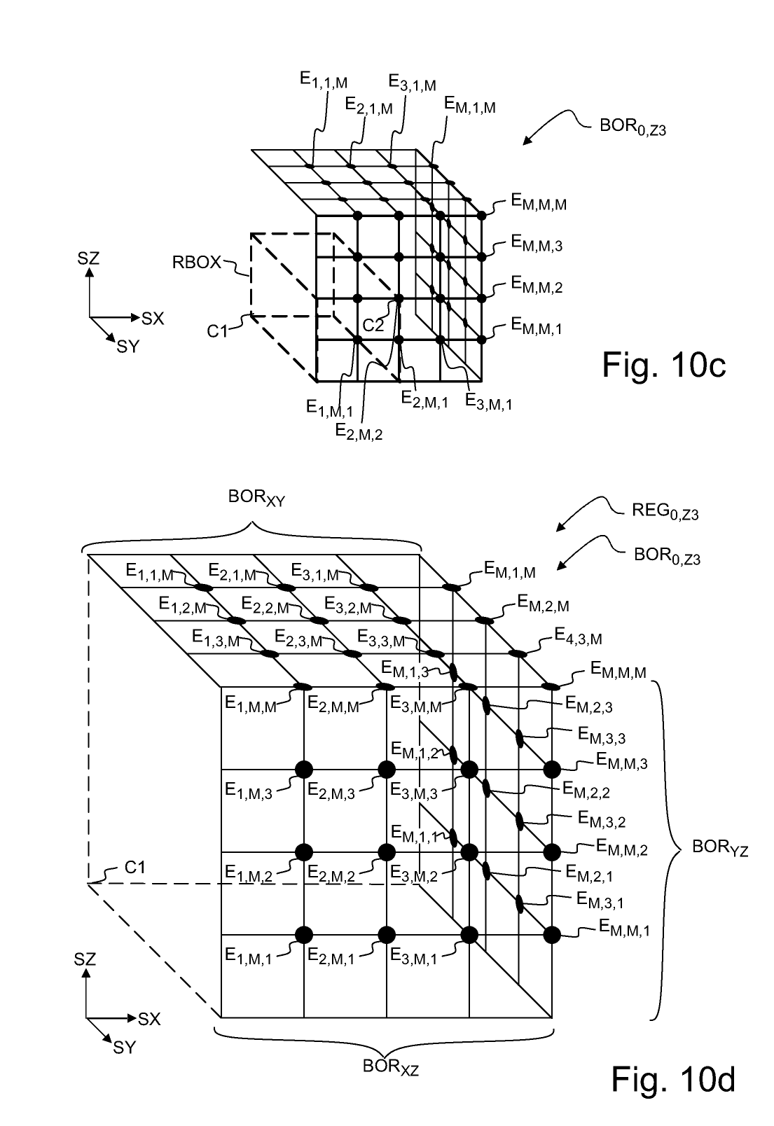

Referring to FIG. 10a, a block REG₀ may be partitioned into eight child blocks REG_{0,0}, REG_{0,1}, REG_{0,2}, REG_{0,3}, REG_{0,4}, REG_{0,0,5}, REG_{0,6}, REG_{0,7}. Each child block may be subsequently partitioned into eight grandchild blocks. For example, the child block REG_{0,0} may be partitioned into eight grandchild blocks REG_{0,0,0}, REG_{0,0,1}, REG_{0,0,2}, REG_{0,0,3}, REG_{0,0,4}, REG_{0,0,5}, REG_{0,0,6}, REG_{0,0,7}, as shown in FIG. 9a.

Referring to FIG. 10b and to FIG. 10c, the cubical block REG₀ may be partitioned into M×M×M cubical elements E according to the integer number M. The integer number M may be equal to 2^{Q}, where Q denotes an integer. Thus, the number M may be e.g. equal to 2¹, 2², 2³, 2⁴, . . . . As shown in FIG. 10b, the number M may be e.g. equal to 4.

The block REG₀ may have the dimensions L_{X1}, L_{Y1}, and L_{Z1} in the directions SX, SY, and SZ, respectively. An individual element E may have dimensions L_{XE}, L_{YE}, and L_{ZE} in the directions SX, SY, and SZ. The dimension L_{XE} may be equal to L_{X1}/M. The dimension L_{YE} may be equal to L_{Y1}/M.

The dimension L_{ZE} may be equal to L_{Z1}/M.

Each element E may have a unique position within the block REG₀. The position of each element E may be specified e.g. by coordinates (x,y,z) of said element E.

The elements E may form a three-dimensional array such that each element E may belong to a row, to a column, and to a layer.

The position of each element E_{i,j,k} may also be specified by indices i,j,k, wherein the first index i may indicate the position of said element E_{i,j,k} in the direction SX, the second index j may indicate the position of said element E_{i,j,k} in the direction SY, and the third index j may indicate the position of said element E_{i,j,k} in the direction SZ. The index i may have an integer value, which is in the range of 1 to M. The index j may have an integer value, which is in the range of 1 to M. The index k may have an integer value, which is in the range of 1 to M. The index i may specify the column of the element E_{i,j,k} within the block. The index j may specify the row of the element E_{i,j,k} within the block. The index k may specify the level of the element E_{i,j,k} within the block.

Each element E_{i,j,k} having i=M, j=M and/or k=M may belong to the border array of the block. For example, elements E_{1,1,M}, E_{1,M,M}, E_{M,1,M}, and E_{M,M,M} may belong to the border array of the block REG₀.

Each element E_{i,j,k} which does not have i=M, j=M and/or k=M may be excluded from the border array of said block. For example, the elements E_{1,1,1} and E_{M-1,M-1,M-1} do not belong to the border array BOR_{0,Z3} of the block REG₀.

Thus, the number of elements of a border vector BOR corresponding to the resolution M may be smaller than the value of the product M×M×M.

FIG. 10c shows, by way of example, determining the values of elements E of the border array BOR_{0,Z3} of a block REG_{0,0}. The value of each element E of a block may be determined by calculating the sum of signal values f of pixels enclosed in a rectangular integration box RBOX, wherein a first corner C1 of the box RBOX is at a predetermined corner of said block, and wherein a second corner C2 of the box RBOX is at the position of said element E. For determining the elements E of the border array of the block, the dimension of at least one side of the integration box RBOX may be equal to the corresponding dimension (L_{X1}, L_{Y1}, or L_{YZ}) of the side of the block REG0,0.

The block REG_{0,0} may be partitioned e.g. into M×M×M sub-blocks. The integer M may be e.g. equal to 4. The spatial resolution of the border array BOR_{0,0,Z3} may correspond to said partition.

An ancestor block (e.g. the block REG₀) may be partitioned into M×M×M descendant blocks. The calculation point P(x,y,z) may define the position of a corner of a summation region SBOX such that the calculation point P(x,y,z) is located within the ancestor block. The integer number M may be determined such that the calculation point P(x,y,z) coincides with the corner of a descendant block of the ancestor block. The integer number M may be determined to be the smallest integer number which fulfils the condition that the calculation point P(x,y,z) coincides with the corner of a descendant block of the ancestor block. The determined integer number M may also indicate the required resolution of the border array of said ancestor block.

FIG. 10d shows the positions of the elements of the border array of the three-dimensional block with respect to said block. The value of each element may represent the sum of signal values of pixels enclosed by a rectangular integration box RBOX, which has a first corner at the corner Cl of the block, and a second corner at the position of said element. Each element may be considered to represent a cubical volume within the block. The cubical volume of an element has eight corners, and the corner having the maximum distance from the corner C1 of the block may be considered to represent the “position” of said element. The positions of the elements have been shown by using black or white (“open”) dots in the drawings.

The elements E of the border array BOR of three-dimensional block REG may be located in a first two-dimensional sub-array BOR_{XZ}, in a second two-dimensional sub-array BOR_{YZ}, and/or in a third two-dimensional sub-array BOR_{XY}. The first sub-array BOR_{XZ} may be in a plane defined by the directions SX and SZ. The second sub-array BOR_{YZ} may be in a plane defined by the directions SY and SZ. The third sub-array BOR_{XY} may be in a plane defined by the directions SX and SY. One or more elements E_{M,M,1}, E_{M,M,2}, E_{M,M,3}, E_{M,M,M} may belong to the first sub-array BOR_{XZ} and to the second sub-array BOR_{YZ}. One or more elements E_{M,1,M}, E_{M,2,M}, E_{M,3,M}, E_{M,M,M} may belong to the second sub-array BOR_{YZ} and to the third sub-array BOR_{XY}. One or more elements E_{1,M,M}, E_{2,M,M}, E_{3,M,M}, E_{M,M,M} may belong to the first sub-array BOR_{XZ} and to the third sub-array BOR_{XY}. The corner element E_{M,M,M} belongs to the first sub-array BOR_{XZ}, to the second sub-array BOR_{YZ} and to the third sub-array BOR_{XY}.

The number of elements of the border array of a block may be equal to 3·M·M−3·M+1 in a situation where the block is partitioned into M×M×M sub-blocks. The number of elements of a border array corresponding to a partition may be smaller than the number of sub-blocks of said partition. For example, the integer M may be equal to 4, the block REG₀ may be partitioned into 4×4×4=64 sub-blocks, and the number of elements of the border array corresponding to said partition may be equal to 3·4·4−3·4+1=37 elements.

FIG. 11a shows a plurality of blocks. A block REG₁ may be adjacent to a block REG₀. The block REG₁ may be partitioned into sub-blocks REG_{1,0}, REG_{1,1}, REG_{1,2}, REG_{1,3}, REG_{1,4}, REG_{1,5}, REG_{1,6}, REG_{1,7}.

FIG. 11a also shows a calculation point P(x,y,z).

Referring to FIG. 11b, the calculation point P(x,y,z) may define a summation region SBOX, which may overlap two or more blocks. For example, the summation region SBOX may overlap the blocks REG₀, REG_{1,0}, REG_{1,2}, REG_{1,4}, REG_{1,6}. The sum of signal values of pixels enclosed by the summation region SBOX may be determined by using the representative elements of the overlapping blocks. Each block which overlaps with the summation region SBOX may provide a single representative element. The blocks may be determined such that they do not overlap with each other.

The block REG₀ may have a representative element ME0. The block REG_{1,0} may have a representative element ME_{1,0}. The block REG_{1,2} may have a representative element ME_{1,2}. The block REG_{1,4} may have a representative element ME_{1,4}. The block REG_{1,6} may have a representative element ME_{1,6.}

The sum of signal values of pixels enclosed by the summation region SBOX may be determined by calculating the sum of the values of the representative elements ME₀,ME_{1,0},ME_{1,2},ME_{1,4},ME_{1,6} of the overlapping blocks.

Blocks which do not overlap with the summation region SBOX do not need to be taken into consideration when determining the sum of signal values of pixels enclosed by the summation region SBOX. In this case, the summation region SBOX does not overlap the regions REG_{1,1}, REG_{1,3}, REG_{1,5}, REG_{1,6}.

The lines LIN1, LIN2, LIN3 may meet at the calculation point P(x,y,z). The lines LIN1, LIN2, LIN3 may indicate edges of the rectangular summation region SBOX.

The representative element of a block may be determined from the elements of the border array of said block such that the representative element has the minimum spatial distance to the calculation point P(x,y,z).

If the boundary of the summation box intercepts the border array of a block, the method may also comprise determining where the boundary of the summation region SBOX intercepts the border array of said block. The representative element of a block may be determined such that the position of the representative element coincides with the position of the calculation point P(x,y,z) in at least one of the directions SX, SY, SZ.

Referring to FIG. 11c, the element E_{M,3,M} of the border array BOR_{0,Z3} may be closest to the calculation point P(x,y,z), when compared with the other elements of said border array BOR_{0,Z3}. In this case, the element E_{M,3,M} may be determined to be the representative element ME₀ of the block REG₀. The boundary line LIN1 of the summation region SBOX may intercept the border array BOR_{0,Z3} of the block REG₀ at the position of the element E_{M,3,M}.

Referring to FIG. 11d, the corner element E_{2,2,2} of the border array BOR_{1,4,Z3} may be closest to the calculation point P(x,y,z), when compared with the other elements of said border array BOR_{1,4,Z3}. In this case, the element E_{2,2,2} may be determined to be the representative element ME_{1,4} of the block REG_{1,4}.

Referring to FIG. 11e, the element E_{2,1,2} of the border array BOR_{1,6,Z3} may be closest to the calculation point P(x,y,z), when compared with the other elements of said border array BOR_{1,6,Z3}. In this case, the element E_{2,1,2} may be determined to be the representative element ME_{1,6} of the block REG_{1,6}.

Referring to FIG. 11f, the element E_{2,2,2} of the border array BOR_{1,0,Z3} may be closest to the calculation point P(x,y,z), when compared with the other elements of said border array BOR_{1,0,Z3}. In this case, the element E_{2,2,2} may be determined to be the representative element ME_{1,0} of the block REG_{1,0}.

Referring to FIG. 11g, the element E_{2,1,2} of the border array BOR_{1,2,Z3} may be closest to the calculation point P(x,y,z), when compared with the other elements of said border array BOR_{1,2,Z3}. In this case, the element E_{2,1,2} may be determined to be the representative element ME_{1,2} of the block REG_{1,2}.

The sum of signal values f of pixels B enclosed by the summation region SBOX may be determined by calculating the sum of the representative values of the blocks which overlap with the summation region SBOX.

In this example, summation region SBOX may overlap the blocks REG₀, REG_{1,0}, REG_{1,2}, REG_{1,4}, REG_{1,6}, and the sum of signal values f of pixels B enclosed by the summation region SBOX may be equal to the sum of the values of the representative elements ME₀,ME_{1,0},ME_{1,2},ME_{1,4}, and ME_{1,6} of said blocks.

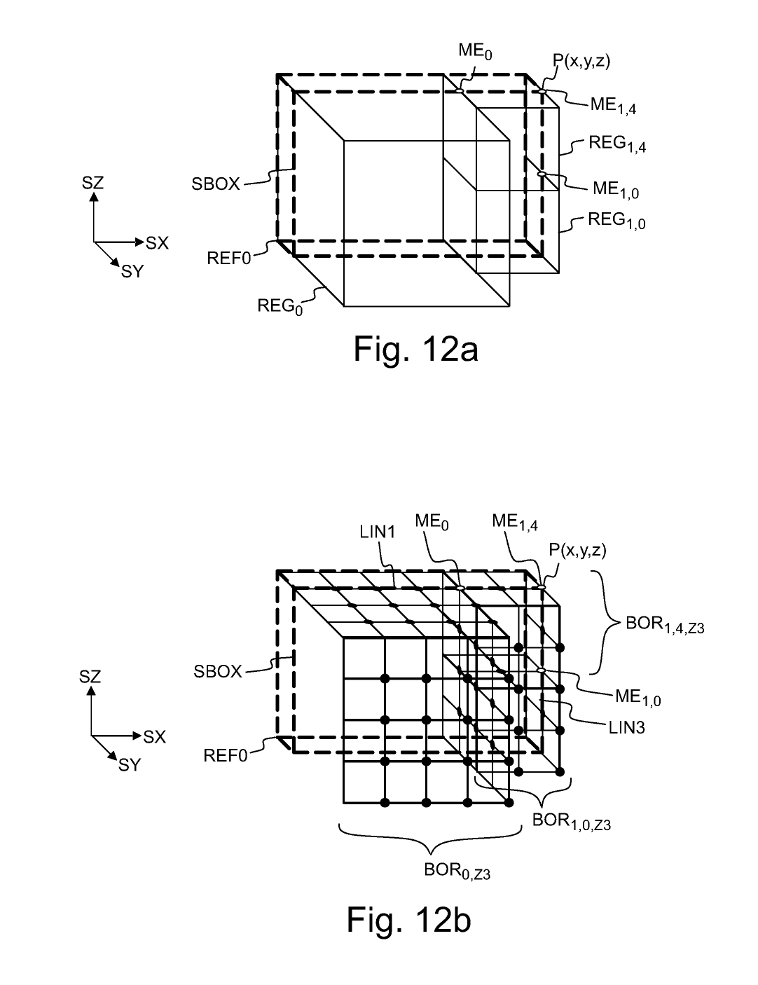

Referring to FIG. 12a, a summation region SBOX may overlap blocks REG₀, REG_{1,0} and REG_{1,4}. The summation region SBOX may have a first at the (global) origin REG₀, and a second corner at a calculation point P(x,y,z).

Referring to FIG. 12b, the sum of signal values f of pixels B enclosed by the summation region SBOX may be determined by calculating the sum of the representative values of the blocks which overlap with the summation region SBOX. In this example, the sum of signal values f of pixels B enclosed by the summation region SBOX may be equal to the sum of the values of the representative elements ME₀,ME_{1,0}, and ME_{1,4}.

The representative element ME₀ of the block REG₀ may be selected from the elements of the border array BOR_{0,Z3} of said block REG₀ such that the representative element ME₀ has the minimum distance to the calculation point P(x,y,z), when compared with the other elements of said border array BOR_{0,Z3}.

The representative element ME_{1,0} of the block REG₀ may be selected from the elements of the border array BOR_{1,0,Z3} of said block REG_{1,0} such that the representative element ME_{1,0} has the minimum distance to the calculation point P(x,y,z), when compared with the other elements of said border array BOR_{1,0,Z3}.

The representative element ME_{1,4} of the block REG_{1,4} may be selected from the elements of the border array BOR_{1,4,Z3} of said block REG_{1,4} such that the representative element ME_{1,4} has the minimum distance to the calculation point P(x,y,z), when compared with the other elements of said border array BOR_{1,4,Z3}.

A 3D pixel (i.e. a voxel) may define a calculation point P(x,y,z). The summation region SBOX may have a first at the (global) origin REG0, and a second corner at the calculation point P(x,y,z). The sum of signal values f of pixels B enclosed by the summation region SBOX may also be called as the integral volume at the pixel (x,y,z).

The integral volume at a pixel (x,y,z) may be calculated e.g. by using the following recursive equation:

$$S ( x , y , z ) = f ( x , y , z ) + S ( x - 1 , y , z ) + S ( x , y - 1 , z ) + S ( x , y , z - 1 ) - S ( x - 1 , y - 1 , z ) - S ( x - 1 , y , z - 1 ) - S ( x , y - 1 , z - 1 ) + S ( x - 1 , y - 1 , z - 1 ) \qquad ( 3 )$$

where f(x,y,z) denotes the signal value at the position (x,y,z),
S(x−1,y,z) denotes the integrated value at the position (x−1,y,z),
S(x,y−1,z) denotes the integrated value at the position (x,y−1,z),
S(x,y,z−1) denotes the integrated value at the position (x,y,z−1),
S(x−1,y−1,z) denotes the integrated value at the position (x−1,y−1,z),
S(x−1,y,z−1) denotes the integrated value at the position (x−1,y,z−1),
S(x,y−1,z−1) denotes the integrated value at the position (x,y−1,z−1), and
S(x−1,y−1,z−1) denotes the integrated value at the position (x−1,y−1,z−1).

The integral volume may be calculated e.g. by using only 8 array access operations. The time needed to calculate the integral volume may be substantially independent of the size of the rectangular integration box.

Storing integral volume data for a large number of pixels may use a lot of memory. The consumption of memory space may be reduced e.g. by partitioning the 3D space into cubical blocks. Each block may be subsequently partitioned into 8 cubical sub-blocks. Each sub-block may be subsequently partitioned into 8 cubical sub-blocks. The cubical blocks of a given zoom level may be arranged in a three-dimensional array.

The first element of this array can be treated as an offset and all the other values can be stored relative to this value, which may require less bits as they may be smaller in size. This method may represent lossless compression.

In another approach, the integral volume of a block may be approximated by using a mean value of the summed pixels inside a block. The difference between the approximated value and the accurate value of the integral volume may be saved in memory e.g. by using a dynamic work length storage. This method may represent lossy compression.

Calculation of the integral volume may be used e.g. for pattern recognition when analyzing a large 3D data set. The 3D data set may be provided e.g. by an imaging system. In particular, the 3D data set may be provided e.g. by using computer tomography (CT) or by magnetic resonance imaging (MRI).

The position of each cubical block may be expressed by a 3-dimensional coordinate (x,y,z), which may be subsequently converted into a 1-dimensional string. The string may be called e.g. as an octkey.

Integral volumes may be used for handling 3D signal data. The signal data may represent e.g. concentration values measured by using a laser measurement system as a function of transverse position (x,y,) and altitude (z). A cubical volume may be partitioned into 8 sub-cubes. When zoomed in, each sub cube may be further partitioned into 8 sub-cubes. Data associated with the cubes and the sub-cubes may be stored e.g. according to a hierarchical tree structure. In particular, the data may be stored according to an octtree structure.

A cubical block may be e.g. at the zoom level 23. The block may be identified e.g. by using an octKey, which can be specified by using 23 bits. The octKey may be appended with 8 bits to specify a spatial position (x,y,z) within the cubical block. Thus, the spatial position (x,y,z) within the cubical block may be fully defined by using 23+8 bits. Thus, the spatial position (x,y,z) within the cubical block may be fully defined by using a 4 byte long integer.

The 3D data may represent a point cloud. The point cloud may be viewed with different resolutions. The points of the point cloud may be downsampled when zooming out. The downsampling process may build points from leaf nodes up to the root node e.g. by using a breadth-first tree-traversal approach.

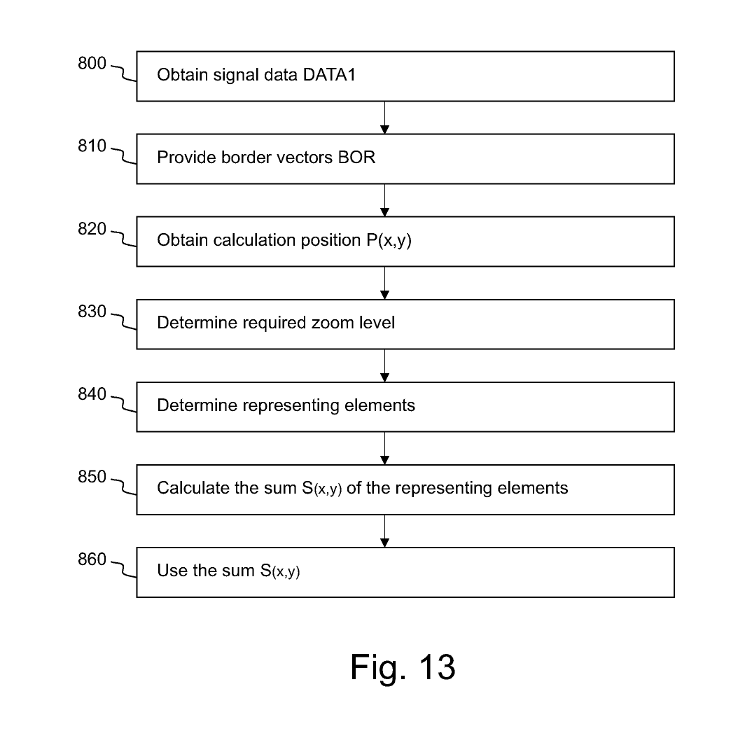

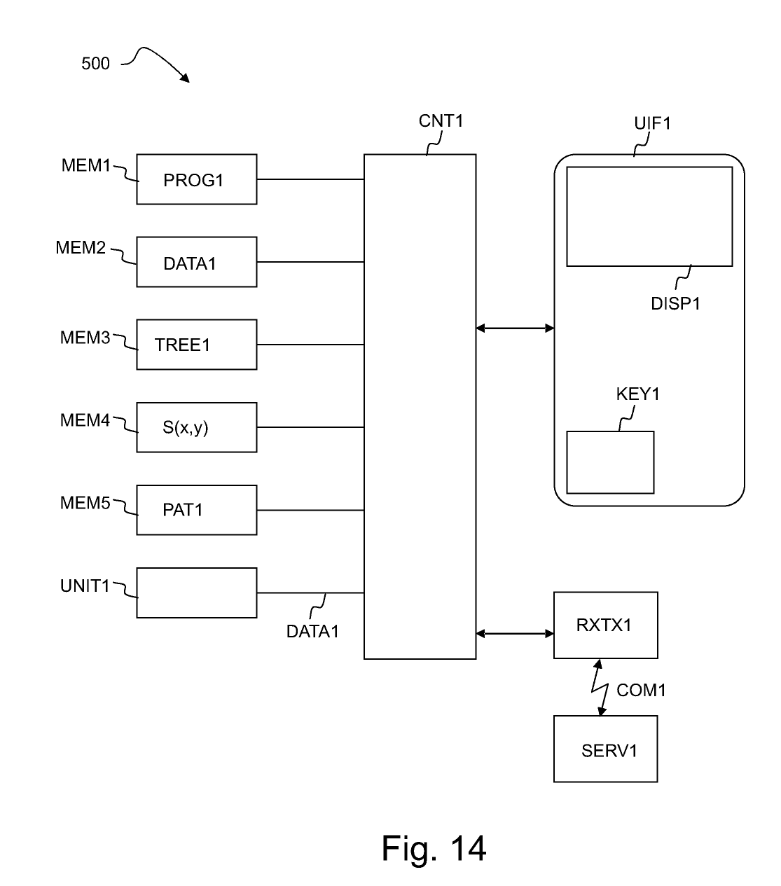

FIG. 13 shows, by way of example, method steps for calculating the sum of representative elements.

In step 800, signal data DATA1 may be obtained. The signal data DATA1 may be obtained e.g. via the Internet or by using a measuring device (e.g. a camera or a measuring instrument).

The signal data DATA1 may also be updated.

In step 810, the border arrays of the blocks may be determined and stored in a memory. Each block may have one or more border arrays, corresponding to the different zoom levels. The border arrays may be stored by using lossy or lossless data compression.

The border arrays may be determined or updated when new signal data is obtained. The border arrays may be updated e.g. when signal values of one or more pixels have been changed. The border array of a block may be updated e.g. when one or more signal values of one or more pixels within said block have been changed. Once the border array of a first block has been determined, the border array of said first block does not need to be updated if signal values of pixels within said first block are not changed. Once the border array of a first block has been determined, the border array of said first block does not need to be updated if signal values of one or more pixels within a second block are changed but if signal values of all pixels within said first block remain unchanged.

The values of the elements of border arrays may be determined e.g. by accessing signal values of the individual pixels, and calculating the sum of the signal values of the pixels enclosed by the integration region. However, a border array of a descendant block of said parent block may already comprise information about the integrated values, and using the border array of the descendant block may facilitate determining the values of the elements of the border array of the parent block. The value of an element of a border array of a parent block may be determined by using a value of an element of a border array of at least one descendant block of said parent block.

In step 820, a calculation position P(x,y) or P(x,y,z) may be determined. The calculation position may coincide e.g. with the point P_{A}, shown in FIG. 1a.

In step 830, the required level of detail (i.e. the zoom level) may be determined. The zoom level may be determined e.g. such that the calculation position coincides with an element of a border array of a block. The zoom level may be lowered until the calculation position coincides with an element of a border array of a block.

In step 840, the representing elements may be determined by using the border arrays.

The border arrays may be stored in a memory (e.g. in the memory MEM3 shown in FIG. 14). The values of the elements of the border arrays may be stored in the memory. The values of the representing elements may be retrieved from the memory. The border arrays may be accessed several times without the need to determine or update the border arrays. A border array of a block may be determined or updated e.g. only when signal values of one or more pixels within said block have been changed. A border array of a block may be accessed several times during a time period without a need to determine or update said border array during said time period. The values of elements of a border array of a block may be retrieved from a memory several times during a time period without a need to determine or update said border array during said time period.

In step 850, the sum S(x,y) or S(x,y,z) of the representing elements ME may be calculated. The sum S(x,y) (or S(x,y,z)) may be equal to the sum of signal values of pixels enclosed by the summation box SBOX, which has a first corner at the global origin REF0 and a second corner at the calculation point P(x,y) (or P(x,y,z)).

Calculating the sum S(x,y) or S(x,y,z) may comprise using the values of the representative elements of two or more blocks. Calculating the sum S(x,y) or S(x,y,z) may comprise calculating the sum of a the values of the representative elements of two or more blocks.

The method may comprise determining a calculation point P(x,y) or P(x,y,z), and retrieving the values of representative elements of border arrays from a memory after said calculation point has been determined. If the calculation point P(x,y) or P(x,y,z) coincides with an element of a border array, the sum S(x,y) or S(x,y,z) may be calculated by using the representative elements of the border arrays without accessing the signal values of individual pixels after said calculation point has been determined.

The border arrays may be determined from the signal data by a first apparatus, and the sum S(x,y) or S(x,y,z) may be calculated by said first apparatus. However, the border arrays may also be determined by a second apparatus, and the values of the elements of the border arrays may be communicated to the first apparatus e.g. via the Internet.

In step 860, the calculated sum may be used e.g. for controlling operation of an apparatus, and/or for pattern recognition. The calculated sum may be used e.g. for determining the regional sum of signal values f of pixels in the region ABCD.

FIG. 14 shows, by way of example, an apparatus 500, which may be configured to calculate the sum S(x,y) (or S(x,y,z)) of the representing elements ME. The apparatus 500 may be arranged to obtain the signal data DATA1 e.g. by using a measurement system, in particular by using an imaging device. The apparatus 500 may be arranged to use the calculated sum for providing a technical effect. For example, the apparatus 500 may be arranged to use the calculated sum for determining whether a pattern matches with a portion of the signal data DATA1.

The method may comprise using the calculated sum for determining whether a pattern PAT1 matches with the signal data DATA1 or not. A reference pattern PAT1 may be formed by using measured data obtained from an imaging unit and/or the signal data DATA1 may be formed by using measured data obtained from an imaging unit. The method may comprise forming the signal data DATA1 and/or a pattern PAT1 by using an imaging unit UNIT1. The method may comprise using the calculated sum for determining whether a captured image PAT1 matches with a portion of a point cloud DATA1. The method may comprise using the calculated sum for determining whether a portion of captured image data DATA1 matches with a portion of a point cloud PAT1.

The apparatus 500 may comprise a control unit CNT1. The control unit CNT1 may comprise one or more data processors for processing data. The control unit CNT1 may control operation of the apparatus 500.

The apparatus 500 may comprise a memory MEM1 for storing computer program PROG1. The computer program may comprise computer program code configured to, when executed on at least one processor, cause an apparatus or a system to determine the sum S(x,y) and/or to use the sum S(x,y) e.g. for pattern analysis.

The apparatus 500 may comprise a memory MEM2 for storing signal data DATA1. The memory MEM2 may store a part of the signal data DATA1 or the entire signal data DATA1.

The apparatus 500 may comprise a memory MEM3 for storing data, which represents the hierarchical tree structure TREE1. The memory MEM3 may comprise e.g. border arrays of the blocks, and/or information for retrieving the values of the elements of the border arrays from a memory.

The apparatus 500 may comprise a memory MEM4 for storing the calculated value of the sum S(x,y).

The apparatus 500 may optionally comprise a memory MEM5 for storing a pattern PAT1. The apparatus 500 may be arranged to use the calculated sum S(x,y) for determining whether the pattern PAT1 matches with the signal data DATA1.

The apparatus 500 may optionally comprise a measurement unit UNIT1 for providing signal data DATA1. The measurement unit may comprise e.g. a camera. The measurement unit may comprise e.g. an X-ray measurement unit. The measurement unit may comprise e.g. a magnetic resonance imaging unit.

The apparatus 500 may optionally comprise a user interface UIF1. The user interface UIF1 may comprise e.g. a display DISP1 and/or an input device KEY1. The user interface UIF1 may provide information to a user, and/or the user interface UIF1 may receive user input from a user, in order to control operation of the apparatus 500. The input device KEY1 may comprise e.g. a touch screen, keypad, keyboard, mouse, joystick, gaze tracking system, and/or a voice recognition system.

The apparatus 500 may optionally comprise a communication unit RXTX1. The communication unit RXTX1 may receive data from an external unit SERV1 and/or receive data from an external unit. The external unit may be e.g. a server. COM1 denotes communication. The communication unit RXTX1 may receive and transmit data e.g. by using a mobile communications network.

Analyzing the signal data DATA1 may comprise pattern recognition. Analyzing the signal data DATA1 may comprise calculating the regional sum for one or more calculation points, and using the regional sum for pattern recognition. Pattern recognition may comprise determining whether a pattern PAT1 matches with the signal data DATA1 or not. The pattern recognition may be performed e.g. by using the Viola-Jones object detection framework. The pattern recognition may comprise comparing rectangular regions of signal data DATA1 with Haar-like features. The comparison may be performed rapidly by using the values S(x,y) of integral images or the values S(x,y,z) of integral volumes. The method may comprise e.g. selection of Haar Features, determining values of an integral image (i.e. the sum of signal values of pixels within the summation box), using the Adaboost training algorithm, and using cascaded classifiers.

The signal values f may be indicative of e.g. intensity values, brightness values, concentration values, and/or absorbance values.

The pattern recognition may be used e.g. for face detection, texture mapping, computer vision, and/or determining stereo correspondence.

The operation of the apparatus 500 or a system may be controlled based on pattern recognition. For example, the apparatus 500 may be arranged to control movements of a device based on pattern recognition. For example, a navigation apparatus 500 may be arranged to output navigation instructions to a user based on pattern recognition. For example, the apparatus 500 may be arranged to automatically steer a vehicle along a route based on pattern recognition. For example, an inspection apparatus 500 may be arranged to capture an image of a produced item, and to determine whether the item passes a quality inspection by comparing the captured image data (DATA1) with a one or more reference images (PAT1). For example, the apparatus 500 may be arranged to retrieve data from a database based on pattern recognition. For example, an image captured by a camera may be compared with one or more reference images (PAT1) in order to determine the identity of a person appearing in the captured image (DATA1). The apparatus 500 may subsequently retrieve data associated with the person from the Internet by using the determined identity. The apparatus 500 may be arranged to retrieve data associated with a person from the Internet in a situation where a reference image PAT1 of said person matches with an image (DATA1) captured by a camera UNIT1.

The apparatus 500 may comprise at least one processor, a memory including computer program code, the memory and the computer program code configured to, with the at least one processor, cause the apparatus to perform one or more method steps mentioned above.

In particular, the apparatus 500 may configured to determine the sum S(x,y) or S(x,y,z) by using the representative elements. The apparatus 500 may be configured to calculate the sum of signal values of pixels located within a summation region by using the representative elements.

The apparatus 500 may be configured to determine values of the elements of the border arrays and/or the border arrays may also be obtained e.g. from an internet server e.g. by using the communication unit RXTX1. The border arrays may be stored in a memory of the apparatus 500 (e.g. in the memory MEM3).

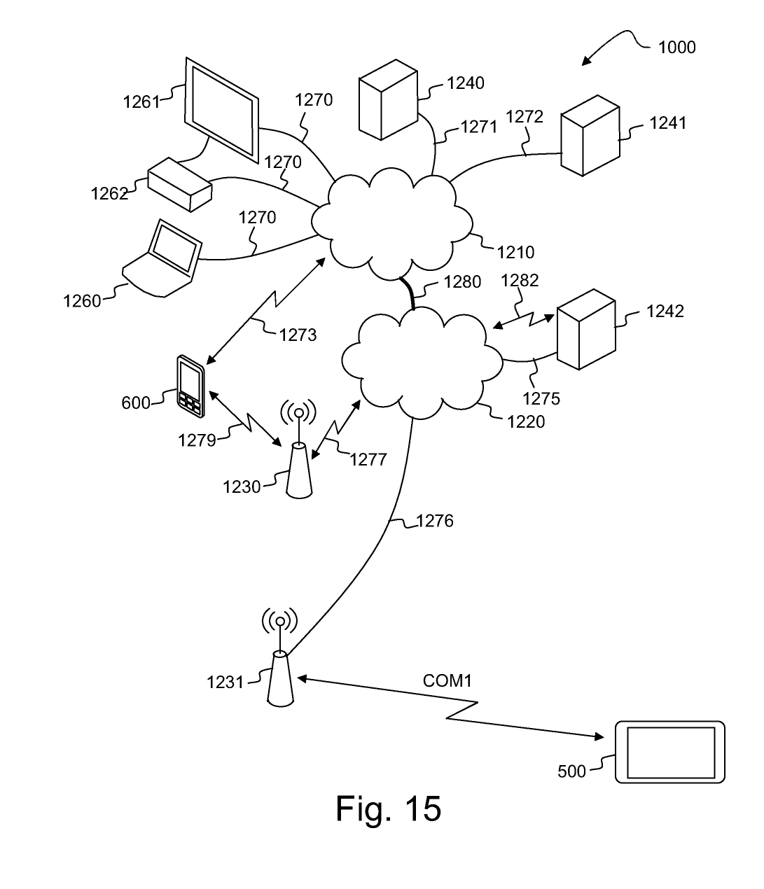

FIG. 15 shows, by way of example, a communication system 1000, which may comprise apparatus 500. In particular, the apparatus 500 may be implemented in a portable device. The apparatus 500 may be a portable device. The system 1000 may comprise a plurality of devices 500, 600, which may be arranged to communicate with each other and/or with a server 1240. One or more devices 500 may comprise a user interface UIF1 for receiving user input. One or more devices 500 and/or a server 1240 may comprise one or more data processors configured to generate the tree TREE1. One or more devices 500 and/or a server 1240 may comprise one or more data processors configured to calculate the sum S(x,y).

The system 1000 may comprise end-user devices such as one or more portable devices 500, 600, mobile phones or smart phones 600, Internet access devices (Internet tablets), personal computers 1260, a display or an image projector 1261 (e.g. a television), and/or a video player 1262. One or more of the devices 500 or portable cameras may comprise an image sensor for capturing image data. A server, a mobile phone, a smart phone, an Internet access device, or a personal computer may be arranged to distribute signal data DATA1. Distribution and/or storing data may be implemented in the network service framework with one or more servers 1240, 1241, 1242 and one or more user devices. As shown in the example of FIG. 15, the different devices of the system 1000 may be connected via a fixed network 1210 such as the Internet or a local area network (LAN). The devices may be connected via a mobile communication network 1220 such as the Global System for Mobile communications (GSM) network, 3rd Generation (3G) network, 3.5th Generation (3.5G) network, 4th Generation (4G) network, Wireless Local Area Network (WLAN), Bluetooth®, or other contemporary and future networks. Different networks may be connected to each other by means of a communication interface 1280. A network (1210 and/or 1220) may comprise network elements such as routers and switches to handle data (not shown). A network may comprise communication interfaces such as one or more base stations 1230 and 1231 to provide access for the different devices to the network. The base stations 1230, 1231 may themselves be connected to the mobile communications network 1220 via a fixed connection 1276 and/or via a wireless connection 1277. There may be a number of servers connected to the network. For example, a server 1240 for providing a network service such as a social media service may be connected to the network 1210. The server 1240 may generate and/or distribute signal data DATA1 and/or border arrays BOR for an application running on the device 500. A second server 1241 for providing a network service may be connected to the network 1210. A server 1242 for providing a network service may be connected to the mobile communications network 1220. Some of the above devices, for example the servers 1240, 1241, 1242 may be arranged such that they make up the Internet with the communication elements residing in the network 1210. The devices 500, 600, 1260, 1261, 1262 can also be made of multiple parts. One or more devices may be connected to the networks 1210, 1220 via a wireless connection 1273. Communication COM1 between a device 500 and a second device of the system 1000 may be fixed and/or wireless. One or more devices may be connected to the networks 1210, 1220 via communication connections such as a fixed connection 1270, 1271, 1272 and 1280. One or more devices may be connected to the Internet via a wireless connection 1273. One or more devices may be connected to the mobile network 1220 via a fixed connection 1275. A device 500, 600 may be connected to the mobile network 1220 via a wireless connection COM1, 1279 and/or 1282. The connections 1271 to 1282 may be implemented by means of communication interfaces at the respective ends of the communication connection. A user device 500, 600 or 1260 may also act as web service server, just like the various network devices 1240, 1241 and 1242. The functions of this web service server may be distributed across multiple devices. Application elements and libraries may be implemented as software components residing on one device. Alternatively, the software components may be distributed across several devices. The software components may be distributed across several devices so as to form a cloud.

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

1. A method for processing a signal data, the signal data representing a spatial region, the method comprising:
providing a first border array associated with a first block, the first border array comprising a first set of elements, wherein a value of each element in the first set of elements corresponds to a sum of signal values of pixels enclosed within an integration region within the first block,
providing a second border array associated with a second block, the second border array comprising a second set of elements, wherein a value of each element in the second set of elements corresponds to a sum of signal values of pixels enclosed within an integration region within the second block,
determining a first representative element from the first border array according to a calculation point,
determining a second representative element from the second border array according to the calculation point, and
calculating a sum of signal values of pixels located within a summation region by using the first representative element and the second representative element, the summation region having a corner at the calculation point.

2. The method according to claim 1, wherein the first representative element is selected such that the first representative element has the minimum distance to the calculation point.

3. The method according to claim 1, wherein a boundary of the summation region meets the first border array.

4. The method according to claim 3, wherein a position of the first representative element coincides with a position of the calculation point in at least one of an orthogonal directions of the coordinate system.

5. The method according to claim 1, wherein the first block is enclosed by the summation region, and the first representative element is a corner element of the first border array.

6. The method according to claim 1, wherein the first block is adjacent to the second block, and the first block is larger than the second block.

7. The method according to claim 1, wherein a number of elements of a first border vector is smaller than a number of pixels contained in the first block.

8. The method according to claim 1, further comprising retrieving the value of each element in the first and the second border arrays by using data stored according to a hierarchical tree structure.

9. The method according to claim 7, further comprising updating the hierarchical tree structure such that a border array of a leaf block is updated, and border arrays of ancestor blocks of the leaf block are updated.

10. The method according to claim 1, further comprising using a calculated sum for determining whether a pattern matches with the signal data or not.

11. The method according to claim 10, further comprising forming the signal data by capturing an image by an imaging unit.

12. The method according to claim 1, further comprising using the calculated sum for determining whether a captured image matches with a point cloud.

13. The method according to according to claim 1, further comprising forming a point cloud by using an imaging unit, and using the calculated sum for determining whether a pattern matches with a portion of the point cloud.

14. The method according to claim 1, further comprising controlling operation of an apparatus by using the calculated sum.

15: A computer program product embodied on a non-transitory computer readable medium, comprising computer program code configured to, when executed on at least one processor, cause an apparatus or a system to:
provide a first border array associated with a first block, the first border array comprising a first set of elements, wherein the value of each element in the first set of elements corresponds to a sum of signal values of pixels enclosed within an integration region within the first block,
provide a second border array associated with a second block, the second border array comprising a second set of elements, wherein a value of each element in the second set of element corresponds to the sum of signal values of pixels enclosed within an integration region within the second block,
determine a first representative element from the first border array according to a calculation point,
determine a second representative element from the second border array according to the calculation point, and
calculate a sum of signal values of pixels located within a summation region by using the first representative element and the second representative element, the summation region having a corner at the calculation point.

16. An apparatus comprising at least one processor, a memory including computer program code, the memory and the computer program code configured to, with the at least one processor, cause the apparatus to at least:
provide a first border array associated with a first block, the first border array comprising a first set of elements, wherein the value of each element in the first set of elements corresponds to a sum of signal values of pixels enclosed within an integration region within the first block,
provide a second border array associated with a second block, the second border array comprising a second set of elements, wherein the value of each element in the second set of elements corresponds to a sum of signal values of pixels enclosed within an integration region within the second block,
determine a first representative element from the first border array according to a calculation point,
determine a second representative element from the second border array according to the calculation point, and
calculate a sum of signal values of pixels located within a summation region by using the first representative element and the second representative element, the summation region having a corner at the calculation point.

17. The apparatus according to claim 16, wherein the first representative element is selected such that the first representative element has the minimum distance to the calculation point.

18. The apparatus according to claim 16, wherein a boundary of the summation region meets the first border array.

19. The apparatus according to claim 18, wherein a position of the first representative element coincides with a position of the calculation point in at least one of an orthogonal directions of the coordinate system.

20. A data structure for processing a signal data, the signal data representing a spatial region, the data structure comprising:
a first border array for a first block,
a second border array for a second block,
a third border array for a first child block of the first block,
a fourth border array for a second child block of the first block,
wherein:
a value of each element of the first border array corresponds to a sum of signal values of pixels enclosed within an integration region within the first block;
a value of each element of the second border array corresponds to a sum of signal values of pixels enclosed within an integration region within said second block;
a value of each element of the third border array corresponds to a sum of signal values of pixels enclosed within an integration region within the third block;
a value of each element of the fourth border array corresponds to a sum of signal values of pixels enclosed within an integration region within the fourth block;
the first block encloses the third block and the fourth block;
the first block does not overlap the second block;
the first border array has a first identifier code;
the second border array has a second identifier code;
the third border array has a third identifier code;
the fourth border array has a fourth identifier code;
the third identifier code comprises a first code section which corresponds to the first identifier code; and
the fourth identifier code comprises a second code section which corresponds to the first identifier code.
